(19) United States
(12) Patent Application Publication
(10) Pub. No.: US 2024/0392046 A1
(43) Pub. Date: Nov. 28, 2024

(54) Plants and Processes for Forming Polymers

(71) Applicant: EXXONMOBIL CHEMICAL PATENTS, Baytown, TX (US)

(72) Inventors: Hamidreza Khakdaman, Houston, TX (US); Jay L. Reimers, Houston, TX (US)

(21) Appl. No.: 18/700,521

(22) PCT Filed: Nov. 17, 2022
(86) PCT No.: PCT/US2022/080038

§ 371 Date: Apr. 11, 2024

Related U.S. Application Data
(60) Provisional application No. 63/282,424, filed on Nov. 23, 2021.

(51) Int. Cl. C08F 10/06; B01J 19/00; B01J 19/06; B01J 19/18

(52) U.S. Cl. CPC C08F 10/06; B01J 19/0013; B01J 19/0066; B01J 19/06; B01J 19/18; B01J 2219/00092; B01J 2219/00103; B01J 2219/00162

(57) ABSTRACT

The present disclosure relates to plants and processes for forming polymers. In some embodiments, a process of forming a polymer includes supplying a. feed having one or more olefin monomers and a solvent. The process includes introducing the feed with a catalyst to form a reaction mixture in a reactor. The process includes moving a. reactor effluent from the reactor and comingling, in a mixer or in a line, the reactor effluent with a first concentrated polymer solution to form a mixture. The process includes introducing the mixture to a heat exchanger to form a heated mixture and introducing the heated mixture to a pressure let down valve followed by introducing the heated mixture to a phase separator. The process includes removing a second concentrated polymer solution from the phase separator. The process includes introducing the second concentrated, polymer solution to the mixer or the line.

### CROSS-REFERENCE TO RELATED APPLICATIONS

This application claims the benefit of U.S. Provisional Application No. 63/282,424, filed on Nov. 23, 2021, the entire contents of which are incorporated herein by reference.

### FIELD

The present disclosure relates to plants and processes for forming polymers.

### BACKGROUND

Continuous solution polymerization processes generally involve the addition of catalyst to a mixture of monomer, co-monomer, and solvent to form a reaction mixture. The reaction mixture may be back-mixed giving a uniform polymer. The heat of the polymerization reaction, called an exotherm, can be absorbed by the reaction mixture. Alternatively, or in addition, the heat of reaction can be removed by a cooling system, such as by external cooling of the walls of the reactor vessel, or by internally arranged heat exchange surfaces cooled by a heat exchange fluid.

In the course of the polymerization, most of the monomers are consumed and the polymers formed remain dissolved in the solvent used during polymerization. Typically, a higher concentration of the polymer results in a higher viscosity polymerization reaction mixture containing the polymer, solvent, and unreacted components. After polymerization, the reaction mixture passes from the polymerization reactor to a finishing section in which the polymer, solvent, and unreacted monomer are separated (e.g., by devolatilization). In the finishing process, solvent and unreacted monomers are progressively removed from the reaction mixture until the polymer can be formed into a solid pellet or bale. The separated solvent and monomer can be recycled to the polymerization reactor.

Devolatilization of polymer is a technique for polymer quality improvement and utilized in the industrial production of adhesives, elastomers, surface coatings, and plastic materials (such as thermosetting and thermoplastic resins). In a devolatilization process, volatile components such as monomers, oligomers, additives, and solvents involved in polymerization, as well as by-products, can be devolatilized from the polymer. The process of devolatilization allows removal of residual voltaile organic compounds (VOCs) from polymers to promote compliance with governmental regulations.

One method for isolating polymers from volatile organic compounds is by evaporation where the polymer solution is heated above the vaporization temperature of the volatile components. The apparatus and method utilized is often dependent on the viscosity of the polymer solution and often these devices have a high initial cost and are costly to operate. To obtain a high output of polymer, very large apparatuses and great expenditures of mechanical energy are typically involved. In addition, these apparatuses impart high temperature and mechanical shear to the polymer and in some cases may cause deterioration of polymer physical properties. In addition, techniques to heat the polymer solution within a zone of heat exchange involve subjecting polymer solutions to high temperatures for prolonged periods of time. Such heat exposure may cause thermal degradation of heat sensitive polymers resulting in discoloration and/or loss of properties, such as impact strength, of the polymer. In addition, techniques to avoid the degradation of heat sensitive polymers can have low output. For example, polymers are generally subjected to mild temperatures and a long residence time within a devolatilization apparatus. Where this occurs, output suffers due to a low flow rate through the devolatilization apparatus.

Heat can be introduced to an effluent from a polymerization reactor by a heat exchanger as it is removed from the polymerization reactor, and the reactor effluent is subsequently introduced to a devolatilization vessel. However, such heat exchangers must provide substantial heat for subsequent devolatilization to occur in a devolatilization vessel, promoting polymer degradation and fouling within the line transferring the reactor effluent and the devolatilization vessel. Alternatively, a concentrated polymer removed from a devolatilization vessel can be recycled directly to the devolatilization vessel via a line coupled with a heat exchanger. The heat exchanger must provide substantial heat for devolatilization to occur and degradation of the polymer and fouling of the recycle line and devolatilization vessel ensues. Moreover, the above-mentioned heat exchangers need to be kept at high pressures to prevent undesirable phase separation of the mixture of polymer and volatiles inside the heat exchanger while operating at the high temperatures.

In addition, the presence of the recycle line described above (and the presence of the recycled concentrated polymer in the devolatilisation vessel upon polymer recycle) makes the residence time of a devolatilization process significantly longer compared to a devolatilization process using a vessel without a recycle line. The residence time can be even longer if the size of the recycle heat exchanger needs to be large because of the high amount of the required heat (provided by recycled concentrated polymer). For example, recycle of 725,000 or more pounds per hour (lb/hr) of recycled concentrated polymer from a devolatilization vessel is typically provided (via a line) to a heat exchanger (operating at 55 MMBtu/hr or greater heat addition to the recycle stream), and then heated recycled polymer is reintroduced directly into the devolatilization vessel. Not only does such additional heating promote polymer degradation, but, in plants that produce multiple different grades of polymers, also makes transition time between production of the different polymer grades very long and costly (due to the large amount of polymer present in the recycle line when the recycle line is turned off to transition to a different polymer grade).

There is a need for devolatilization plants and processes that provide, e.g., reduced transition time between polymer grades in a way that also reduces the amount of off-spec material produced (e.g., degraded polymer and less recycled concentrated polymer in a recycle line).

### SUMMARY

In some embodiments, a process of forming a polymer includes supplying a feed having one or more olefin monomers and a solvent. The process includes introducing the feed with a catalyst to form a reaction mixture in a reactor. The process includes removing a reactor effluent from the reactor and comingling, in a mixer or in a line, the reactor effluent with a first concentrated polymer solution to form a mixture. The process includes introducing the mixture to a heat exchanger to form a heated mixture and introducing the heated mixture to a pressure let down valve followed by introducing the heated mixture to a phase separator. The process includes removing a second concentrated polymer solution from the phase separator. The process includes introducing the second concentrated polymer solution to the mixer or the line.

In some embodiments, a plant for forming a polymer includes a polymerization reactor coupled with a phase separator. The plant includes a heat exchanger and a pressure let down valve disposed between the polymerization reactor and the phase separator. The heat exchanger is coupled with the polymerization reactor and the pressure let down valve. The pressure let down valve coupled with the phase separator. The plant includes a stream splitter coupled with the phase separator and coupled with a line at a location upstream of the heat exchanger and the pressure let down valve.

These and other features and attributes of viscosity modifiers of the present disclosure and their advantageous applications and/or uses will be apparent from the detailed description which follows.

### BRIEF DESCRIPTION OF THE FIGURES

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally effective aspects.

FIG. 1 is a schematic layout of plant and process flow for polymerization and devolatilization, according to an embodiment.

FIG. 2 is a sechematic layout of a portion of the plant and process flow of FIG. 1 (during a normal operation mode), according to an embodiment.

FIG. 3A illustrates a phase separator of the plant and process flow of FIG. 1, according to an embodiment.

FIG. 3B illustrates a phase separator of the plant and process flow of FIG. 1, according to an embodiment.

FIG. 4 is a heat exchanger, according to an embodiment.

FIG. 5 is a plate heat exchanger, according to an embodiment.

FIG. 6 is a plate heat exchanger, according to an embodiment.

FIG. 7 is a plate heat exchanger, according to an embodiment.

To facilitate understanding, identical reference numerals have been used, where possible, to designate identical elements that are common to the figures. The figures are not drawn to scale and may be simplified for clarity. It is contemplated that elements and features of one aspect may be beneficially incorporated in other aspects without further recitation.

### DETAILED DESCRIPTION

The present disclosure relates to plants and processes for forming polymers.

In some embodiments, a process of forming a polymer includes supplying a feed having one or more olefin monomers and a solvent. The process includes introducing the feed with a catalyst to form a reaction mixture in a reactor and removing a reactor effluent from the reactor. The process includes comingling, in a mixer or in a line, the reactor effluent with a first concentrated polymer solution to form a mixture. The process includes introducing the mixture to a heat exchanger to form a heated mixture. The process includes introducing the heated mixture to a pressure let down valve followed by introducing the heated mixture to a phase separator. The process includes removing a second concentrated polymer solution from the phase separator. The process includes introducing the second concentrated polymer solution to the mixer or the line.

In some embodiments, a plant for forming a polymer includes a polymerization reactor coupled with a phase separator. The plant includes a heat exchanger and a pressure let down valve disposed between the polymerization reactor and the phase separator. The heat exchanger is coupled with the polymerization reactor and the pressure let down valve, and the pressure let down valve is coupled with the phase separator. The plant includes a stream splitter coupled with the phase separator and coupled with a line at a location upstream of the heat exchanger and the pressure let down valve.

Plants and processes of the present disclosure provide reactor effluent mixed with a recycle stream of concentrated polymer solution (from a phase separator, also referred to as a devolatilization vessel). The mixture can be passed through a heat exchanger before entering the phase separator. Heat exchange can also be performed using a heat exchanger disposed within the phase separator. Because heat exchange is provided to the mixture at two or more locations, each of the two or more heat exchange processes (of the two or more heat exchangers) can be performed at a lower temperature than a conventional single heat exchange, providing reduced amount of off-spec material (e.g., degraded polymer) in the polymer product produced. Otherwise, addition of all of the heat in an initial heat exchanger would substantially increase the outlet temperature of the heat exchanger, leading to undesirable phase separation of effluent. In addition, supplying a large amount of heat in the phase separator itself would otherwise make the vessel very large.

In addition, a heat exchanger disposed within a devolatilization vessel of the present disclosure provides heat to the concentrated polymer solution exiting the phase separator which, in addition to mixing the concentrated polymer solution with reactor effluent before the initial heat exchange, provides a reduced amount of heat that can be used in the initial heat exchange (further reducing polymer degradation). Because the initial heat exchange (of the reactor effluent and recycled concentrated polymer solution) does not require substantial heat, a reduced amount of recycled concentrated polymer solution can be used during normal operation mode of the plant. Because a reduced amount of recycled concentrated polymer solution can be used during normal operation mode, reduced transition time between polymer grades is provided in addition to reduced amounts of off-spec material being produced (e.g., degraded polymer and less recycled concentrated polymer solution in the recycle line). For example, in some embodiments, recycle of 500,000 or less pounds per hour (lb/hr) of recycled concentrated polymer from a devolatilization is used in a plant and/or process of the present disclosure, such as 400,000 or less lb/hr, such as about about 100,000 lb/hr to about 400,000 lb/hr, such as about 200,000 lb/hr to about 300,000 lb/hr.

In addition, the presence of recycled concentrated polymer solution in the initial heat exchanger provides reduced or eliminated phase separation (liquid-liquid or vapor-liquid) of the mixture inside the heat exchanger, which would otherwise cause heat transfer and operational issues.

For a transition mode, plants and processes of the present disclosure provide the recycle stream of concentrated polymer solution to be closed during grade transition without substantial amounts of off-spec material being created (e.g., stagnant concentrated polymer inside the recycle line and heat exchanger of the line). In other words, a devolatilization can have a reduced devolatilization residence time, e.g., a reduction in devolatilization residence time of ⅓ or more, as compared to conventional devolatilization processes.

In addition, heat exchangers of the present disclosure (e.g., disposed within the devolatilization vessel) can have a tube-tube design where the tubes are assembled in a bundle to provide, for example, up to 8000 m² of surface area. As compared to conventional tube bundles, a heat exchanger of the present disclosure can provide substantial distribution of the reactor effluent (or mixture of reactor effluent and concentrated polymer solution) to increase the vapor-liquid interface of the reactor effluent (or mixture of reactor effluent and concentrated polymer solution).

### Polymerization Conditions

In some embodiments, provided is a process of forming a polymer including: (a) supplying a feed having one or more olefin monomer(s) and a solvent; (b) introducing the feed with a catalyst in a reactor; and (c) removing a reactor effluent from the reactor for further processes.

In one or more embodiments, the reactor may be a single reactor or multiple reactors, for example two reactors arranged in parallel or in series. One or more of the reactors may be a loop reactor. Additionally or alternatively, a reactor is a continuous stirred tank reactor. In one or more embodiments, two reactors are arranged in parallel or in series, and the internal volume of the first reactor to the internal volume of the second reactor may have a minimum ratio value of 50:50, 55:45, 60:40, 65:35, 70:30, 80:10, 85:15, or 90:10, and a maximum ratio value of 55:45, 60:40, 65:35, 70:30, 80:20, 85:15, 90:10, or 95:5, so long as the maximum ratio value is greater than the minimum ratio value. The reaction mixtures from the two reactors are combined and then passed to the phase separator.

Monomers and catalysts may be supplied into the reactor(s) by any suitable units or apparatus. The plant may include a feed supplying unit for supplying a feed having one or more olefin monomers in a solvent, for example, a hydrocarbon solvent. A plant of the present disclosure may also include a catalyst supply unit suitable for supplying a catalyst to the reactor. The feed supply units suitable for supplying a feed of one or more olefin monomers in a solvent to the reactor may be any suitable apparatus, but will typically include a conduit for the supply of each of the monomers, a conduit for the supply of recycled solvent, and a conduit for the supply of fresh solvent. Each of these conduits may be fed to a common feed conduit prior to entry into the reactor. A pump or pumps may be used to pump the feed to the reactor or reactors and to pressurize the feed to the desired pressure. The catalyst supply units suitable for supplying a catalyst to the reactor may be any suitable apparatus, but will typically include a conduit for the supply of the catalyst, and optionally a pump or pumps to pump the catalyst to the reactor or reactors.

A solvent used for polymerization can be any suitable solvent, such as hexane and/or isohexane. For example, the solvent is a non-polar solvent which does not coordinate or interfere with the catalyst in a meaningful way so as to inhibit the catalytic action of the catalyst system. A process of the present application can use a low boiling alkane based solvent, or mixtures thereof, which may be linear or branched, such as those having from 4 to 10 carbon atoms, preferably from 5 to 7 carbon atoms, optionally in admixture with other alkanes of a higher or lower molecular weight.

The polymer may be derived of monomers comprising mono-olefins such as ethylene or propylene or other higher alpha-olefins having from 4 to 10 carbon atoms. This combination provides a mixture which can be easily separated inside the liquid phase separator.

Working pressures in the reactor(s) described herein can be 8 MPa or more, 9 MPa or more; 10 MPa or more, 12 MPa or more, or 14 MPa or more. The upper pressure limit may not be critically constrained, but typically can be 20 MPa or less, such as 18 MPa or less, or 15 MPa or less, or 14 MPa or less, or 12 MPa or less. In some embodiments, the pressure is sufficient to keep the reaction mixture in a single phase and to provide the working pressure to convey the fluids through the plant.

The feed temperature may vary depending on the available exotherm and extent of monomer conversion desired to reach the polymerization temperature. In some embodiments, the temperature is not higher than 40° C., or not higher than 20° C., or not higher than 0° C., or not higher than −20° C. The polymerization temperature may vary from the desired molecular weight of the polymers allowing for the influence of any chain transfer agent, for example hydrogen added. In a series reactor process, the temperature in the successive reactors can be raised progressively in increments depending on the nature of the polymerization taking place in such reactors. In some embodiments, the polymerization temperature for polymers comprising predominantly (e.g., 50 wt % or more) ethylene derived units is at least 100° C., or at least 150° C., or 200° C. or more, varying for the particular polymer being synthesized. The temperature should not exceed the polymerization decomposition temperature or the temperature at which the catalyst can sustain the polymerization reaction.

Overall, the exotherm may lead to a temperature differential between the inlet temperature of the polymerization reactor and the outlet temperature of 50° C. to 220° C. or up to 250° C. In one or more embodiments, by feeding the feed at minus 40° C. and allowing the exotherm to raise the temperature to 210° C., a process may result for producing lower molecular weight polymers. For higher molecular weight polymers, the temperature rise may need to be constrained via warmer feed and/or lower reactor temperatures to avoid excessive viscosity in the reactor solution that would degrade reactor mixing performance, thereby leading to non-uniform polymers.

Monomer concentration may depend on the types of target polymer and molecular weight, the associated conversions of monomer to polymer and the operating temperature. For example, the monomer concentration can be higher than 10 wt %, or 15 wt %, and lower than 80 wt %, 70 wt %, or 60 wt %. The total vapor pressure of all components may be less than 100 wt %/of the reactor pressure at the stream temperature to avoid formation of vapor bubbles.

Polymerization can be performed with any suitable catalysts, for example, a Ziegler Natta catalyst, a single sited catalyst (SSC) or metallocene catalyst. In one or more embodiments, a SSC or metallocene catalyst can be used. The term “metallocene” means one or more cyclopentadienyl moiety in combination with a transition metal of the Periodic Table of Elements. As used herein, the numbering scheme for the Periodic Table of the Elements is used as set out in CHEMICAL AND ENGINEERING NEWS, 63(5), 27 (1985).

Metallocene catalysts generally contain a transition metal of Groups 3 to 10 of the Periodic Table; and at least one ancillary ligand that remains bonded to the transition metal during polymerization. In some embodiments, the transition metal is used in a cationic state and stabilized by a cocatalyst or activator. In some embodiments, metallocenes of Group 4 of the Periodic Table are used such as titanium, hafnium or zirconium which are used in polymerization in the mono-valent cationic state and have one or two ancillary ligands.

In some embodiments, the catalyst is a bulky ligand transition metal catalyst. The “bulky ligand” contains a multiplicity of bonded atoms, such as carbon atoms, forming a group, which may be cyclic with one or more heteroatoms. The bulky ligand may be metallocene-type cyclopentadienyl derivative, which can be mono- or poly-nuclear. One or more bulky ligands may be bonded to the transition metal atom. Other ligands may be bonded or coordinated to the transition metal, such as detachable by a cocatalyst or activator, such as a hydrocarbyl or halogen-leaving group. Detachment of any such ligand leads to the creation of a coordination site at which the olefin monomer can be inserted into the polymer chain. In some embodiments, the transition metal atom is a Group 4, 5 or 6 transition metal of the Periodic Table of Elements, such as a Group 4 atom.

Metallocene catalysts can be used with a cocatalyst which may be alumoxane, such as methylalumoxane having an average degree of oligomerization of 4 to 30 as determined by vapor pressure osmometry. Alumoxane may be modified to provide solubility in linear alkanes or be used in slurry, but can be generally used from a toluene solution. Such solutions may include unreacted trialkyl aluminum and the alumoxane concentration can be generally indicated as mol Al per liter, which figure includes any trialkyl aluminum which has not reacted to form an oligomer. The alumoxane, when used as cocatalyst, can be generally used in molar excess, at a mol ratio of 50 or more, such as 100 or more, such as 1000 or less, such as 500 or less, relative to the transition metal.

The SSC may be selected from among a broad range of available SSCs to suit the type of polymer being made and the process window associated therewith in such a way that the polymer can be produced under the process conditions at an activity of at least 40,000 g polymer per gram SSC (or a metallocene), such as at least 60,000 or even in excess of 100,000 g polymer per gram SSC. By enabling the different polymers to be produced in different operating windows with a suitable catalyst selection, the SSC and ancillary catalyst components can be used in small quantities, with optionally also using small amounts of scavengers.

A metallocene may be also used with a cocatalyst which can be a non-coordinating anion (the term “non-coordinating anion” as used herein includes weakly coordinated anions, and the coordination may be sufficiently weak in any event as evidenced by the progress of polymerization to permit the insertion of the unsaturated monomer component). The non-coordinating anion may be supplied and reacted with the metallocene in any suitable manner.

The precursor for the non-coordinating anion may be used with a metallocene supplied in a reduced valency state. The precursor may undergo a redox reaction. The precursor may be an ion pair of which the precursor cation can be neutralized and/or eliminated in some manner.

The non-coordinating anion can be a halogenated, tetra-aryl-substituted Group 10-14 non-carbon element-based anion, especially those that have fluorine groups substituted for hydrogen atoms on the aryl groups, or on alkyl substituents on those aryl groups.

The effective Group 10-14 element cocatalyst complexes, in some embodiments, derived from an ionic salt, include a 4-coordinate Group 10-14 element anionic complex, where the anion can be represented by the formula:

[(M)Q¹Q² . . . Qᵢ]⁻

where M is one or more Group 10-14 metalloid or metal, preferably boron or aluminum, and each Q is a ligand effective for providing electronic or steric effects rendering [(M)Q¹Q² . . . Qᵢ]⁻ suitable as a non-coordinating anion, or a sufficient number of Q are such that [(M)Q¹Q² . . . Qᵢ]⁻as a whole is an effective non-coordinating or weakly coordinating anion. Exemplary Q substituents specifically include fluorinated aryl groups, preferably perfluorinated aryl groups, and include substituted Q groups having substituents additional to the fluorine substitution, such as fluorinated hydrocarbyl groups. Preferred fluorinated aryl groups include phenyl, biphenyl, naphthyl and derivatives thereof.

The non-coordinating anion may be used in approximately equimolar amounts relative to the transition metal component, such as at least 0.25, preferably 0.5, and especially 0.8 and such as no more than 4, preferably 2 and especially 1.5.

Representative metallocene compounds can have the formula:

L^{A}L^{B}L^{C}ᵢMDE

where L^{A} is a substituted cyclopentadienyl or hetero-cyclopentadienyl ancillary ligand n-bonded to M; L^{B} is a member of the class of ancillary ligands defined for L^{A}, or is J, a hetero-atom ancillary ligand σ-bonded to M; the L^{A} and L^{B} ligands may be covalently bridged together through a Group 14 element linking group; L^{C}ᵢ is an optional neutral, non-oxidizing ligand having a dative bond to M (i equals 0 to 3); M is a Group 4 or 5 transition metal; and, D and E are independently mono-anionic labile ligands each having a σ-bond to M, optionally bridged to each other or L^{A} or L^{B}. The mono-anionic ligands are displaceable by a suitable activator to permit insertion of a polymerizable monomer or macro-monomer for coordination polymerization on the vacant coordination site of the transition metal component.

Representative non-metallocene transition metal compounds usable as SSCs also include tetrabenzyl zirconium, tetra bis(trimethylsiylmethyl) zirconium, oxotris(trimethlsilylmethyl) vanadium, tetrabenzyl hafnium, tetrabenzyl titanium, bis(hexamethyl disilazido)dimethyl titanium, tris(trimethyl silyl methyl) niobium dichloride, and tris(trimethylsilylmethyl) tantalum dichloride.

Additional organometallic transition metal compounds suitable as olefin polymerization catalysts in accordance with the aspects described herein will be any of those Group 3-10 that can be converted by ligand abstraction into a catalytically active cation and stabilized in that active electronic state by a non-coordinating or weakly coordinating anion sufficiently labile to be displaced by an olefinically unsaturated monomer such as ethylene.

Metallocenes may be used which are biscyclopentadienyl derivatives of a Group 4 transition metal, preferably zirconium or hafnium, for example, as disclosed in WO 99/41294. These may advantageously be derivatives containing a fluorenyl ligand and a cyclopentadienyl ligand connected by a single carbon and silicon atom, for example, as disclosed in WO 99/45040 and WO 99/45041. In some embodiments, the Cp ring is unsubstituted and/or the bridge contains alkyl substituents, suitably alkylsilyl substituents to assist in the alkane solubility of the metallocene, for example as disclosed in WO 00/24792 and WO 00/24793. Other possible metallocenes include those in WO 01/58912.

WO 97/03992 incorporated herein by reference shows a catalyst in which a single Cp species and a phenol are linked by a C or Si linkage, such as Me₂C(Cp)(3-tBu-5-Me-2-phenoxy)TiCl₂. WO 2001/05849 incorporated herein by reference discloses Cp-phosphinimine catalysts, such as (Cp)((tBu)₃P═N—)TiCl₂.

Other suitable metallocenes may be bisfluorenyl derivatives or unbridged indenyl derivatives which may be substituted at one or more positions on the fused ring with moieties which have the effect of increasing the molecular weight and indirectly permits polymerization at higher temperatures such as described in EP 0693506 and EP 0780395.

When using the catalysts described above, the total catalyst system will generally additionally include one or more organometallic compounds as scavenger(s). Such scavenger(s) include those compounds effective for removing polar impurities from the reaction environment and for increasing catalyst activity. Impurities can be inadvertently introduced with any of the polymerization reaction components, particularly with solvent, monomer and catalyst feed, and adversely affect catalyst activity and stability, which can result in decreasing or even eliminating catalytic activity, particularly when ionizing anion precursors activate the catalyst system. The impurities, or catalyst poisons include water, oxygen, polar organic compounds, metal impurities, etc. In some embodiments, steps are taken to remove these poisons before introduction of such into the reaction vessel, for example by chemical treatment or careful separation techniques after or during the synthesis or preparation of the various components, but some minor amounts of organometallic compound will still normally be used in the polymerization process itself.

Scavengers can be organometallic compounds such as the Group-13 organometallic compounds of U.S. Pat. Nos. 5,153,157 and 5,241,025, International Publication Nos. WO 91/09882, WO 94/03506, WO 93/14132, and WO 95/07941. Exemplary compounds include triethyl aluminum, triethyl borane, tri-isobutyl aluminum, tri-n-octyl aluminum, methylalumoxane, and isobutyl alumoxane. Alumoxane also may be used in scavenging amounts with other means of activation, e.g., methylalumoxane and tri-isobutyl-aluminoxane with boron-based activators. The amount of scavenger to be used with catalyst compounds can be minimized during polymerization reactions to that amount effective to enhance activity (and with that amount necessary for activation of the catalyst compounds if used in a dual role) since excess amounts may act as catalyst poisons.

Polymerizations providing a wide variety of polymer types and molecular weights can be performed. Generally speaking, the polymers are derived from either ethylene or propylene as the dominant (e.g., more than 50 wt %) component. Polymers may preferably contain from 5 mol % to 40 mol % of comonomers to vary crystallinity and flexibility. The comonomers may be alpha-olefins (under which term cyclic olefins such as styrene are included) having from 2 to 20 carbon atoms, such as ethylene (in the case of the polymer consisting predominantly of propylene derived units), propylene, 1-butene, 1-hexene, and 1-octene. Amounts of dienes such as hexadiene, vinyl norbornene, ethylidene norbornene (ENB), norbornadiene, etc., may be included to promote unsaturation and/or the formation of longer branches themselves made from polymerized monomer derived units.

In the case of plastomer, the polymer which may be produced can include the following aspects: the comonomer is an alpha-olefin having from 3 to 15 carbon atoms, such as 4 to 12 carbon atoms, such as 4 to 10 carbon atoms. Ethylene can be polymerized with at least two comonomers to form a terpolymer. Ethylene can be polymerized in a proportion of 70 mol % to 99.99 mol %, such as 70 mol % to 97 mol %, such as 80 mol % to 95 mol % of ethylene with 0.01 mol % to 30 mol %, such as 3 mol % to 30 mol %, such as 5 mol % to 20 mol % comonomer. The molecular weight distribution of a polymer can be determined with a Waters Gel Permeation Chromatograph equipped with Ultra-styrogel columns and a refractive index detector. The operating temperature of the instrument can be set at 145° C., the eluting solvent can be trichlorobenzene, and the calibration standards can include sixteen polystyrenes of precisely known molecular weight, ranging from a molecular weight of 500 to a molecular weight of 5.2 million, and a polyethylene standard, NBS 1475.10. The molecular weight distribution of the plastomers produced may have a narrow molecular weight distribution, that is, an Mw/Mn can be less than or equal to 3, such as less than or equal to 2.5. The MI of the polymers can be 0.01 dg/min to 200 dg/min, such as 0.1 dg/min to 100 dg/min, such as 0.2 dg/min to 50 dg/min, such as less than 10 dg/min. A plastomer can have a density of 0.85 g/cm³ to 0.93 g/cm³, such as 0.87 g/cm³ to 0.92 g/cm³, such as 0.88 g/cm³ to 0.91 g/cm³.

The processes described herein may involve copolymerization reactions involving the polymerization of one or more of the monomers, for example alpha-olefin monomers of ethylene, propylene, 1-butene, 1-pentene, 1,4-methyl-1-pentene, 1-hexene, 1-octene, 1-decene and cyclic olefins such as styrene. Other monomers may include polar vinyl, dienes, norbornene, acetylene, and aldehyde monomers.

In the case of elastomer, the polymer which may be produced includes an ethylene-alpha-olefin-diene elastomer (EODE) of high Mw and a diene content of greater than 0.3 wt %, such as greater than 2 wt %. These polymers may be largely amorphous and have a low or zero heat of fusion. As used herein, the term “EODE” encompasses elastomeric polymers included of ethylene, alpha-olefin, and one or more non-conjugated diene monomers. The non-conjugated diene monomer may be a straight chain, branched chain or cyclic hydrocarbon diene having from 6 to 15 carbon atoms. Examples of suitable non-conjugated dienes are straight chain acyclic dienes such as 1,4-hexadiene and 1,6-octadiene; branched chain acyclic dienes such as 5-methyl-1,4-hexadiene; 3,7-dimethyl-1,6-octadiene; 3,7-dimethyl-1,7-octadiene and mixed isomers of dihydromyricene and dihydroocinene; single ring alicyclic dienes such as 1,4-cyclohexadiene and 1,5-cyclododecadiene; and multi-ring alicyclic fused and bridged ring dienes such as tetrahydroindene, methyl tetrahydroindene, dicyclopentadiene; bicyclo-1,5-(2,2,1)-hepta-2,5-diene; alkenyl, alkylidene, cycloalkylidene norbornenes such as 5-methylene-2-norbomene (MNB); 5-propenyl-2-norbornene, 5-isopropylidene-2-noabornene, 5-(4-cyclopentenyl)-2-norbornene, 5-cyclohexylidene-2-norbornene, 5-vinyl-2-norbornene and norbomadiene.

Suitable dienes used to prepare ethylene-propylene-diene elastomers (EPDMs) can be 1,4-hexadiene (HD), 5-ethylidene-2-norbornene (ENB), 5-vinylidene-2-norbornene (VNB), 5-methylene-2-norbornene (MNB), and dicyclopentadiene (DCPD). In at least one embodiment, dienes are 5-ethylidene-2-norbornene (ENB) and 1,4-hexadiene (HD), such as EOD elastomers may contain 20 wt % up to 90 wt % ethylene, such as 30 wt % to 85 wt % ethylene, such as 35 wt % to 80 wt % ethylene, based on the weight of EOD elastomer. The alpha-olefin suitable for use in the preparation of elastomers with ethylene and dienes can be propylene, 1-butene, 1-pentene, 1-hexene, 1-octene and 1-dodecene. In at least one embodiment, the alpha-olefin is incorporated into the EODE polymer at 10 wt % to 80 wt %, such as at 20 wt % to 65 wt %, based on the weight of the EODE polymer. The non-conjugated dienes are generally incorporated into the EODE at 0.5 wt % to 20 wt %, such as at 1 wt % to 15 wt %, such as at 2 wt % to 12 wt %, based on the weight of the EODE polymer. If desired, more than one diene may be incorporated simultaneously, for example HD and ENB, with total diene incorporation within the limits specified above. In at least one embodiment of the present disclosure, the elastomer can be a low viscosity polymer, such as low viscosity Vistamaxx™ (LVV).

In at least one embodiment, suitable elastomers may also be a copolymer of two monomers. Such copolymers may be elastomers of relatively high Mw, low crystallinity, and low ash. The copolymers may be ethylene-alpha-olefin-copolymers of high Mw. The ethylene-alpha-olefin-copolymers may be copolymers of ethylene and an alpha-olefin, not necessarily propylene, which exhibits the properties of an elastomer. The alpha-olefins suitable for use in the preparation of elastomers with ethylene can be C₃ to C₁₀ alpha-olefins. Illustrative non-limiting examples of such alpha-olefins are propylene, 1-butene, 1-pentene, 1-hexene, 1-octene and 1-dodecene. In at least one embodiment, more than one alpha-olefin may be incorporated. The ethylene-alpha-olefin-copolymers may contain 20 wt % up to 90 wt % ethylene, such as 30 wt % to 85 wt % ethylene, such as 35 wt % to 80 wt % ethylene.

In at least one embodiment, the elastomers may be propylene-based polymers having predominantly (50 wt % or more) of propylene derived units.

In at least one embodiment, the propylene-based polymers can be composed of propylene and at least one comonomer, and optionally a diene. The comonomer may be ethylene or an alpha-olefin. Comonomers include ethylene and linear or branched C₄ to C₃₀ alpha-olefins, or combinations thereof. Suitable linear alpha-olefins include ethylene and C₄ to C₈ alpha-olefins, such as ethylene, 1-butene, 1-hexene, and 1-octene, such as ethylene or 1-butene. Suitable branched alpha-olefins include 4-methyl-1-pentene, 3-methyl-1-pentene, and 3,5,5-trimethyl-1-hexene. In at least one embodiment, propylene copolymer can be a random copolymer, as the term is defined herein below. A diene may also be included in the propylene-based polymer. In at least one embodiment, diene includes non-conjugated dienes which are straight chain acyclic dienes such as 1,4-hexadiene and 1,6-octadiene; branched chain acyclic dienes such as 5-methyl-1,4-hexadiene; 3,7-dimethyl-1,6-octadiene; 3,7-dimethyl-1,7-octadiene and mixed isomers of dihydromyricene and dihydroocinene; single ring alicyclic dienes such as 1,4-cyclohexadiene and 1,5-cyclododecadiene; and multi-ring alicyclic fused and bridged ring dienes such as tetrahydroindene, methyl tetrahydroindene, dicyclopentadiene; bicyclo-1,5-(2,2,1)-hepta-2,5-diene; alkenyl, alkylidene, cycloalkylidene norbomenes such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbomene, 5-vinyl-2-norbomene and norbornadiene. The propylene-based polymer may include 1,4-hexadiene (HD), 5-ethylidene-2-norbornene (ENB), 5-vinylidene-2-norbornene (VNB), 5-methylene-2-norbornene (MNB), and dicyclopentadiene (DCPD).

In at least one embodiment, the propylene-based polymer may have a crystallinity of 2% to 65%. Within this range of crystallinity, alternative limits of crystallinity can be from about 5% to about 50%, such as about 10% to about 45%, such as about 15% to about 40%. The crystallinity of the propylene-based polymer is derived from isotactic (or alternatively syndiotactic) polypropylene sequences in the copolymer. In at least one embodiment, the amount of propylene may be from 65 wt % to 95 wt %, such as about 70 wt % to 92%, such as about 80 wt % to 89 wt %.

In at least one embodiment, a propylene-based polymer has a single broad melting transition. Sample of the propylene-based polymer may show secondary melting peaks or shoulders adjacent to the principal peak, and this combination is considered together as single melting point, i.e., a single broad melting transition. The highest of these peaks is considered the melting point. In at least one embodiment, a propylene-based polymer has a melting point of 25° C. to 110° C., such as 30° C. to 105° C., such as 35° C. to 90° C.

The propylene-based polymer can be a random crystallizable copolymer having a narrow compositional distribution. The intermolecular composition distribution of the polymer is determined by thermal fractionation in a solvent. Suitable solvent can be a saturated hydrocarbon, such as isohexane or hexane. The thermal fractionation procedure is described below. In at least one embodiment, approximately 75 wt % or greater, such as about 85 wt % of the polymer is isolated as one or two adjacent soluble fractions with the balance of the polymer in immediately preceding or succeeding fractions. Each of these fractions has a composition (wt % ethylene content) with a difference of not greater than 20% (relative), such as not greater than 10% (relative) from the average wt % ethylene content of the propylene-based polymer. For purposes of the present disclosure, the propylene-based polymer can be considered to have a “narrow” compositional distribution if it meets the fractionation test outlined above.

The length and distribution of stereoregular propylene sequences in suitable propylene-based polymers can be consistent with substantially random statistical copolymerization. Without being bound by theory, sequence length and distribution are related to the copolymerization reactivity ratios. As used herein, the term “substantially random” means a copolymer for which the product of the reactivity ratios is about 2 or less. In contrast, in stereoblock structures, the average length of PP sequences is greater than that of substantially random copolymers with a similar composition.

The reactivity ratios and sequence distribution of the polymer may be determined by ¹³C NMR which locates the ethylene residues in relation to the neighboring propylene residues. To produce a crystallizable copolymer with an amount of randomness and narrow composition distribution needed, it may be desirable to use (1) a single-site catalyst and (2) a well-mixed, loop polymerization reactor which allows only a single polymerization environment for substantially all of the polymer chains of suitable propylene-based polymers.

Suitable propylene-ethylene copolymers are described in U.S. Pat. No. 6,635,715, the contents of which is hereby incorporated by reference.

Commercial examples of polymers formed by processes and plants of the present disclosure can include Vistamaxx™ copolymers from ExxonMobil Chemical Company, Tafmer™ elastomers from Mitsui Chemicals, and Versify™ elastomers from Dow Chemical Company.

For example, Vistamaxx™ is a propylene-based elastomer that extends the performance and processability of films, compounds, nonwovens and molded/extruded products. The free flowing pellets of Vistamaxx™ are easy to incorporate and the broad compatibility allows dry blending operations. Vistamaxx™ offers a range of applications such as, for example, 1) nonwovens (elasticity, softness and toughness; delivered with drop-in processing performance); 2) films (elasticity, sealability, toughness and tack); 3) polymer modification and compounds (impact strength, transparency, flexibility/stiffness, softness, high filler loading). Vistamaxx™ copolymers are copolymers of propylene and ethylene. Vistamaxx™ are propylene rich (>80%) and are semi-crystalline materials with high amorphous content. Synthesis of Vistamaxx™ polymers has been typically based on ExxonMobil Chemical's Exxpol™ technology.

Vistamaxx™ 6102 (“VM6102”) is a propylene-ethylene copolymer having a density of 0.862 g/cm³, melt index (at 190° C., 2.16 kg) of 1.4 g/10 min, MFR of 3 g/10 min, and ethylene content of 16 wt %.

Vistamaxx™ 3980 propylene-ethylene performance polymer (“VM3980”) is available from ExxonMobil Chemical Company. VM3980 has an ethylene content of 9 wt % with the balance being propylene. Properties of VM3980 include: a density of 0.879 g/cm³ (ASTM D1505); a melt index of 3.6 g/10 min (ASTM D1238; 190° C., 2.16 kg); a melt mass flow rate of 8 g/10 min (230° C., 2.16 kg); a Shore D hardness of 34 (ASTM D2240); and a Vicat softening temperature (VST) of 77.3° C.

Vistamaxx™ 6502 (VM6502) is a polymer having isotactic propylene repeat units with random ethylene distribution; the polymer having a density of 0.865 g/cm³; melt mass flow rate of 45.2 g/10 min (230° C., 2.16 kg); and an ethylene content of 13.1 wt %.

Vistamaxx™ 3000 propylene-ethylene performance polymer (“VM3000”) is available from ExxonMobil Chemical Company. VM3000 has an ethylene content of 11 wt % with the balance being propylene. Properties of VM3000 include: a density of 0.873 g/cm³ (ASTM D1505); a melt index of 3.7 g/10 min (ASTM D1238; 190° C., 2.16 kg); a melt mass flow rate of 8 g/10 min (230° C., 2.16 kg); a Shore D hardness of 27 (ASTM D2240); and a Vicat softening temperature (VST) of 65.1° C.

Vistamaxx™ 3588 propylene-ethylene performance polymer (“VM3588”) is available from ExxonMobil Chemical Company. VM3588 has an ethylene content of 4 wt % with the balance being propylene. Properties of VM3588 include: a density of 0.889 g/cm³ (ASTM D1505); a melt mass flow rate of 8 g/10 min (230° C., 2.16 kg); a Shore D hardness of 50 (ASTM D2240); and a Vicat softening temperature (VST) of 103° C.

Vistamaxx™ 6202 (“VM6202”) is a propylene-ethylene copolymer having a density of 0.863 g/cm³, melt index (at 190° C., 2.16 kg) of 9.1 g/10 min, MFR of 20 g/10 min, and ethylene content of 15 wt %.

Vistamaxx™ 3020 (“VM3020”) is a propylene-ethylene copolymer having a density of 0.874 g/cm³, melt index (at 190° C., 2.16 kg) of 1.1 g/10 min, MFR of 3 g/10 min, and ethylene content of 11 wt %.

Plants and processes of the present disclosure provide transition between different grades of polymers, such as Vistamaxx™ grades of polymers, having reduced amounts of off-spec material (e.g., degraded polymer and/or non-degraded polymer outside of a desirable specification range) in a way that also provides reduced transition time between the polymer grades and reduced amounts of recycled polymer in a recycle line, as compared to conventional plants and processes.

### Plants and Process Flow

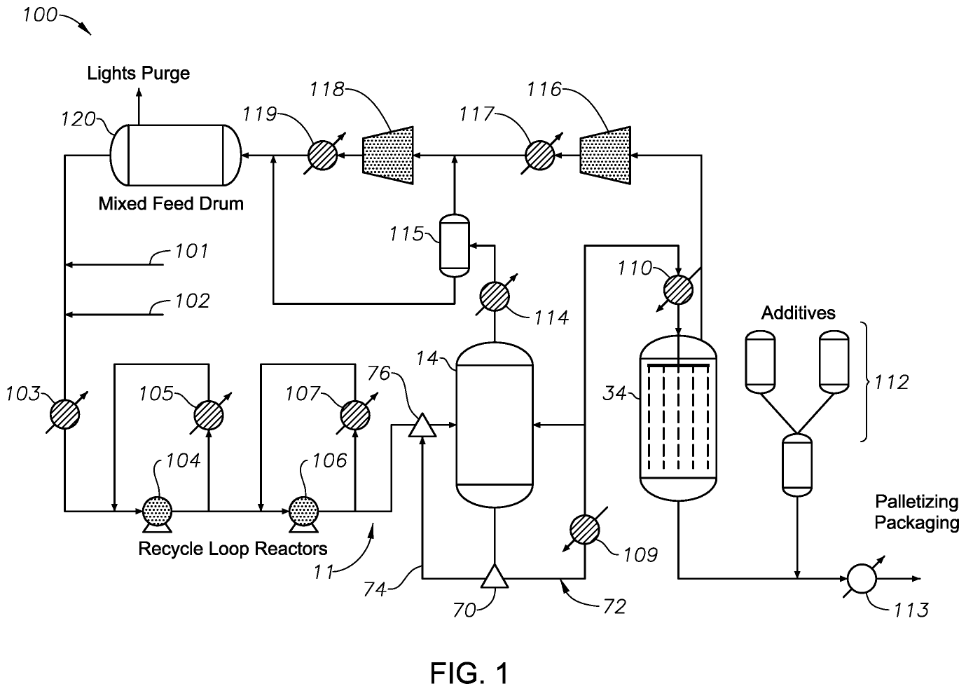

FIG. 1 is a plant (100) and process flow for polymerization and devolatilization, according to an embodiment.

As shown in FIG. 1, a monomer stream (101) and a catalyst compound stream (102) may be introduced into the plant 100 and mixed to form a solution. A solvent (such as isohexane) is also present. The solution of monomer and catalyst compound may travel through a chiller or heater (103) to arrive at a suitable temperature. Then the chilled or heated solution of monomer and catalyst compound may be pumped through a pump (104) into a first heat exchanger (105) in a reaction zone. Prior to introduction into the first heat exchanger, the catalyst compound may be contacted (not shown) with an activator as described herein to form a catalyst system. In some embodiments, the catalyst compound is contacted with the activator immediately prior to entering the first heat exchanger.

As the catalyst system contacts the monomer, in a solution, in the first heat exchanger (105), polymer is obtained. The monomer, catalyst system, and polymer may flow through the first heat exchanger (105) in a cross-flow direction relative to the first heat exchanger (105). A portion of the monomer, catalyst system, and polymer exiting the first heat exchanger (105) may be recycled back to the first heat exchanger (105), and another portion of the monomer, catalyst system and polymer exiting the first heat exchanger may be pumped via another pump (106) into a second heat exchanger (107) in a reaction zone. A portion of the monomer, catalyst system, and polymer exiting the second heat exchanger (107) may be recycled back to the second heat exchanger (107), and another portion of the monomer, catalyst system, and polymer exiting the second heat exchanger (107) may be transferred to a phase separator/devolatilization vessel (14). Additionally or alternatively, the activator may be introduced in the recycle streams (not shown). First heat exchanger (105) and second heat exchanger (107) are shown in series, but may alternatively be in parallel.

In the phase separator (14), monomer and/or solvent is separated from polymer. A concentrated polymer solution may exit the bottom of the phase separator (14) and is passed to a stream splitter (70) which splits the concentrated polymer solution into a first stream which, via line (72), is transferred to a low-pressure separator (34) where evaporated solvent and monomer are separated from the more concentrated polymer solution emerging from the phase separator (14). Stream splitter (70) also splits the concentrated polymer solution into a second stream (a recycle stream) which, via line (74), is transferred to line (11) at a location upstream of a heat exchanger (not shown) for mixing with reactor effluent. In some embodiments, a third separator (not shown) may be utilized. A third separator is typically operated at a lower pressure and higher temperature than separator (34). In some embodiments, the third separator can be operated at a pressure about 5 torr to about 40 torr and/or a temperature of about 130° C. to about 220° C.

A heater (109) of line (72) to form a heated concentrated polymer solution. A portion of the heated concentrated polymer solution may be recycled to phase separator (14). A remaining portion of the heated concentrated polymer solution may be further heated in a heater (110) of line (72) to maintain the heated concentrated polymer solution in a molten phase, and then transferred to low-pressure separator (34) to remove any remaining monomer and/or solvent from the heated concentrated polymer solution. A more concentrated polymer solution (up to about 100% polymer) may exit the bottom of the low-pressure separator (34), where it may be (1) treated in a third stage devolatilization (e.g., low-pressure separator) (not shown) or (2) mixed with further suitable additives (112), chilled in a chiller (113) and then sent to pelletizing and packaging. Likewise, a more concentrated polymer solution may exit the bottom of the third stage devolatilization vessel (not shown) and be mixed with suitable additives (112), chilled in chiller (113), and then sent to pelletizing and packaging.

Conditions of phase separator (14) during devolatilization can include a temperature (e.g., average temperature of an interior volume of the phase separator) of about 150° C. to about 180° C., a pressure of about 75 psig to about 150 psig, and/or a mass flow rate (e.g., of first and/or second concentrated polymer solution(s)) of about 200 Mlb/hr to about 1000 Mlb/hr, such as about 250 Mlb/hr to about 775 Mlb/hr. Polymer content of the reactor effluent that enters phase separator (14) is about 10 wt % to about 25 wt %.

Polymer content of the effluent of phase separator (14) that enters low-pressure separator (34) is about 25 wt % to about 45 wt %. Low-pressure separator (34) can be operated at about 180° C. to about 200° C. and a pressure of about 25 psig to about 50 psig.

Polymer content of the effluent exiting low-pressure separator (34) can be about 80 wt % to about 95 wt %, such as about 88 wt % to about 91 wt %. If a third stage devolatilization is performed, a third separator (not shown) can be operated at a temperature of about 200° C. to about 220° C. and a pressure of about 20 torr (0.39 psig) to about 50 torr (0.97 psig). The effluent exiting the third separator can have less than about 500 wppm volatile organic compounds (VOC).

The monomer and solvent exiting the top of the phase separator (14) may then be cooled in a chiller (114) and transferred to a condenser (115). Condensed monomer and/or solvent may exit the bottom of the condenser (115) and be transferred to a mixed feed drum (120), so that it may be fed back into the system. Noncondensable gases (e.g., hydrogen gas, ethylene gas) may exit the top of the condenser (115) and be transferred to a compressor (118) and another chiller (119) to convert the gases to liquids, which may then be transferred to the mixed feed drum (120) for use again in the system. Similarly, the monomer and/or solvent exiting the top of the low-pressure separator (34) may be passed through a compressor (116), another chiller (117), the compressor (118) and the chiller (119) to form a liquid, which may then be transferred to the mixed feed drum (120) for use again in the system.

### Non-Limiting Polymerization Examples

Table 1 illustrates example polymerization processes to make a low molecular weight plastomer, a higher molecular weight elastomer, and a high propylene content ethylene copolymer polymerized as described above. In some embodiments, a plant is operated with one or more of the conditions provided in Table 1.

TABLE 1
Process Conditions of the Plant/Process of the Invention in Varying Operating Modes

| | | | Polymer Solution | Polymer Solution |
|---|---|---|---|---|
| | | Polymerization | Upstream Let- | Downstream Let- |
| | Feed Into Reactor | Inside Reactor | Down Valve | Down Valve |
| Plastomer | 0 or down to −15° C.; | 150--200° C.; 100 or | 220° C.; 100 or 120 | 220° C.; 4 to 14 |
| | 120 bar total; 50 bar | 120 bar; 15-22 wt % | bar, 15-22 wt % | bar; 15-22 wt % |
| | monomer partial | polymer | polymer | polymer |
| | pressure. | | | |
| Elastomer | 0 or down to −15° C.; | 100° C.; 100 or 120 | 220° C.; 100 or 120 | 220° C.; 4 to 14 |
| | 120 bar total; 50 bar | bar; 8-12 wt % | bar, 8-12 wt % | bar; 8-12 wt % |
| | monomer partial | polymer | polymer | polymer |
| | pressure. | | | |
| Predominant | 0 or down to −15° C.; | 50 or 60° C.; 120 | 200° C., 120 bar, 7-8 | 200° C.; 4 to 14 |
| Propylene | 120 bar total; 50 bar | bar; 7-8 wt % | wt % polymer | bar; 7-8 wt % |
| Content | monomer partial | polymer | | polymer |
| Copolymer | pressure. | | | |

To make plastomer using a plant of FIG. 1, the feed temperature can be reduced by the heater/chiller (103) to 0° C. Aluminum alkyl is added as scavenger in amounts appropriate to the poison content of the feed. The pressure is raised by the centrifugal pump to 120 bar. The feed comprising largely solvent and up to 50 bar partial pressure of ethylene and propylene or butene or hexene or octene comonomer then enters the first heat exchanger (105) (e.g., the first reactor of the series of reactors). Catalyst and activator is added to the first heat exchangers (105/107) in amounts to create a desired polymerization temperature which in turn is related to a desired molecular weight of polymer formed. The heat of polymerization increases the temperature to 150 to 200° C. to form a plastomer without the use of hydrogen (although H₂ may be used). At the outlet of the second series reactor, the polymer concentration is in the range of 10-25 wt %.

Water is then supplied via a line (not shown) to quench the polymerization reaction which might otherwise continue in the presence of surviving catalyst, unreacted monomer, and elevated temperature.

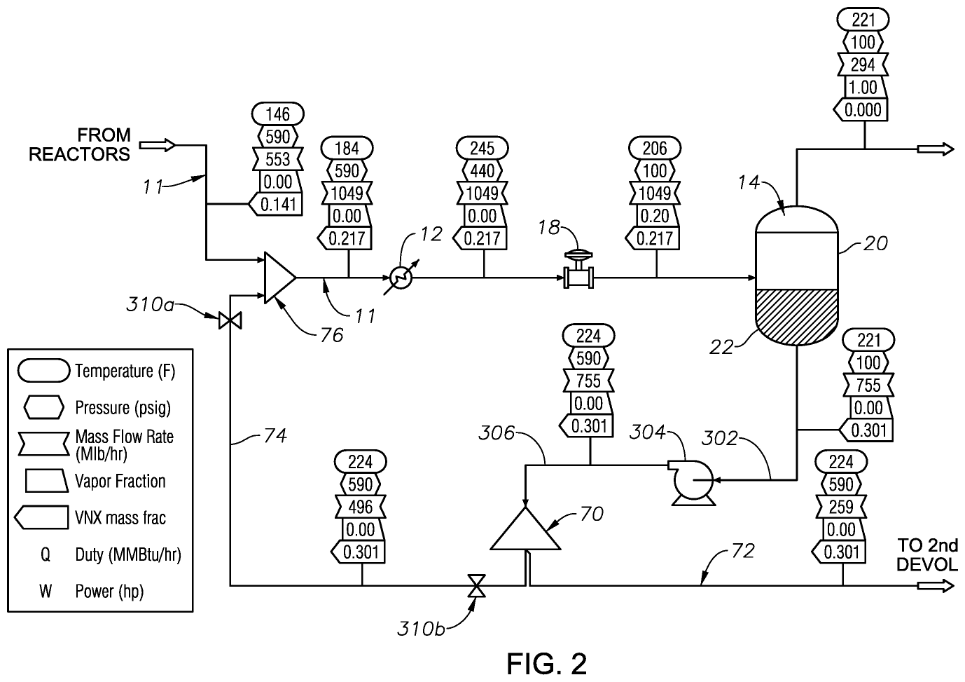

A heat exchanger raises the temperature initially and the concentrated polymer solution of recycle line (74) (in addition to a heat exchanger disposed within phase separator (14) as described in more detail below) causes a further temperature rise. A rapid pressure drop results as the polymerization mixture passes through the let-down valve (18) (of FIG. 2) into the phase separator (14), with the pressure dropping quickly. The pressure differential between the outlet of the pump of the reactor and the outlet of the let down valve (18) is responsible for causing the feed and the polymerization mixture to flow through the heat exchanger(s) (105/107) and the line (11) including the heat exchanger (12).

If the use of the plant is now compared with the row in Table 1 marked elastomer, it can be seen that although the polymerization temperature is lower than for plastomer, and the reactor effluent emerging from the reactor is lower (its viscosity will be similar to that for plastomers), the same separation process and plant can be used to give an output which is somewhat lower (reflecting the reduced efficiency of the polymerization process at lower temperatures). With two reactors in series, it may be preferable that the first reactor operates at temperatures of 0 to 110° C. and the second reactor operates at temperature of 40 to 140° C., such as the first reactor operates at temperature of 10 to 90° C. and the second reactor operates at temperature of 50 to 120° C., such as the first reactor operates at temperature of 20 to 70° C. and the second reactor operates at temperature of 60 to 110° C. With appropriate control of process conditions and poison levels, temperature of this order of magnitude can also be obtained where one reactor only is used or two reactors are used under the same process conditions.

The same can be said about the row in Table 1 marked “Predominant propylene content copolymer” where the temperature is lowered to allow the less reactive propylene monomer to form a sufficiently high molecular weight.

Plants and processes of the present disclosure permit polymerization and subsequent polymer separation across a broad range of temperatures to yield polymers of widely varying average molecular weights and comonomer contents with catalyst for operation at low or high operating temperatures. A process plant according to the present disclosure is capable of production of plastomers, elastomers, and/or predominant propylene content copolymers by changing only the polymerization starting materials (e.g., catalyst, monomer, and/or comonomer) and the process conditions.

FIG. 2 is a portion of plant (100) during a normal operation mode, according to an embodiment. As shown in FIG. 2, line (11) transfers a reactor effluent that is comingled with concentrated polymer solution of recycle line (74). The reactor effluent and the concentrated polymer solution can be comingled directly into line (11) or, as shown in FIG. 2, can be comingled via a mixer (76) followed by continued transfer of the mixture via line (11) to heat exchanger (12).

As mentioned above, plants of the present disclosure can be operated under a normal operation mode where concentrated polymer solution of recycle line (74) is comingled with reactor effluent of line (11). Alternatively, during a transition mode, only reactor effluent is provided via line (11) to phase separator (14) and recycle of concentrated polymer solution is ceased. For example, valves (310a) and/or (310b)(each shown in an open position in FIG. 2) can be in a closed position to cease the comingling of concentrated polymer solution of recycle line (74) with reactor effluent of line (11). A transition mode can be performed if transitioning grades of polymer or transitioning between entirely different polymers.

During a normal operation mode or a transition mode, the reactor effluent of line (11) introduced to mixer (76) can have a temperature of about 130° F. to about 330° F., such as about 140° F. to about 320° F., a pressure of about 550 psig to about 800 psig, such as about 580 psig to about 650 psig, a mass flow rate of about 400 Mlb/hr to about 700 Mlb/hr, such as about 500 Mlb/hr to about 600 Mlb/hr, a vapor content of about 0 wt %, and/or a polymer content of about 5 wt % to about 35 wt %, such as about 10 wt % to about 30 wt %. The concentrated polymer solution of recycle line (74) (from stream splitter (70)) introduced to mixer (76) can have a temperature of about 200° F. to about 300° F., such as about 215° F. to about 280° F., a pressure of about 550 psig to about 800 psig, such as about 580 psig to about 650 psig, a mass flow rate of about 350 Mlb/hr to about 630 Mlb/hr, such as about 450 Mlb/hr to about 540 Mlb/hr, a vapor content of about 0 wt %, and/or a polymer content of about 20 wt % to about 60 wt %, such as about 25 wt % to about 50 wt %.

From mixer (76), the reactor effluent (or mixture of the reactor effluent and concentrated polymer solution) is transferred to heat exchanger (12). During normal operation mode (where the reactor effluent and the concentrated polymer solution are comingled), the mixture of the reactor effluent and the concentrated polymer solution of line (11) between mixer (76) and heat exchanger (12) can have a temperature of about 150° F. to about 310° F., such as about 180° F. to about 280° F., a pressure of about 550 psig to about 800 psig, such as about 580 psig to about 650 psig, a mass flow rate of about 800 Mlb/hr to about 1200 Mlb/hr, such as about 1025 Mlb/hr to about 1075 Mlb/hr, a vapor content of about 0 wt %, and/or a polymer content of about 10 wt % to about 30 wt %, such as about 18 wt % to about 22 wt %. During transition mode (where the reactor effluent and the concentrated polymer solution are not comingled), the reactor effluent of line (11) between mixer (76) and heat exchanger (12) can have a temperature of about 130° F. to about 330° F., such as about 140° F. to about 320° F., a pressure of about 550 psig to about 800 psig, such as about 580 psig to about 650 psig, a mass flow rate of about 400 Mlb/hr to about 700 Mlb/hr, such as about 500 Mlb/hr to about 600 Mlb/hr, a vapor content of about 0 wt %, and/or a polymer content of about 5 wt % to about 35 wt %, such as about 10 wt % to about 30 wt %.

From heat exchanger (12), the mixture of the reactor effluent and concentrated polymer solution is transferred to let down valve (18). During normal operation mode, the mixture of reactor effluent and concentrated polymer solution of line (11) being transferred from heat exchanger (12) to let down valve (18) can have a temperature of about 220° F. to about 360° F., such as about 240° F. to about 340° F., a pressure of about 400 psig to about 600 psig, such as about 435 psig to about 550 psig, a mass flow rate of about 400 Mlb/hr to about 1100 Mlb/hr, such as about 500 Mlb/hr to about 1060 Mlb/hr, a vapor content of about 0 wt % to about 1 wt %, such as about 0 wt %, and/or a polymer content of about 10 wt % to about 50 wt %, such as about 15 wt % to about 40 wt %. During transition mode, the reactor effluent of line (11) being transferred from heat exchanger (12) to let down valve (18) can have a temperature of about 220° F. to about 350° F., such as about 240° F. to about 330° F., a pressure of about 400 psig to about 600 psig, such as about 435 psig to about 550 psig, a mass flow rate of about 400 Mlb/hr to about 600 Mlb/hr, such as about 450 Mlb/hr to about 560 Mlb/hr, a vapor content of about 0 wt % to about 1 wt %, such as about 0 wt %, and/or a polymer content of about 5 wt % to about 35 wt %, such as about 10 wt % to about 30 wt %.

From let down valve (18), the mixture of the reactor effluent and concentrated polymer solution is transferred to phase separator (14). During normal operation mode, the mixture of reactor effluent and concentrated polymer solution of line (11) being transferred from let down valve (18) to phase separator (14) can have a temperature of about 170° F. to about 300° F., such as about 200° F. to about 270° F., a pressure of about 50 psig to about 200 psig, such as about 70 psig to about 170 psig, a mass flow rate of about 350 Mlb/hr to about 1100 Mlb/hr, such as about 400 Mlb/hr to about 1100 Mlb/hr, a vapor content of about 10 wt % to about 60 wt %, such as about 15 wt % to about 50 wt %, and/or a polymer content of about 10 wt % to about 50 wt %, such as about 15 wt % to about 40 wt %. During transition mode, the reactor effluent of line (11) being transferred from let down valve (18) to phase separator (14) can have a temperature of about 170° F. to about 300° F., such as about 190° F. to about 280° F., a pressure of about 50 psig to about 200 psig, such as about 60 psig to about 170 psig, a mass flow rate of about 400 Mlb/hr to about 700 Mlb/hr, such as about 500 Mlb/hr to about 600 Mlb/hr, a vapor content of about 10 wt % to about 50 wt %, such as about 20 wt % to about 40 wt %, and/or a polymer content of about 5 wt % to about 35 wt %, such as about 10 wt % to about 30 wt %.

From phase separator (14), the concentrated polymer solution that is formed in the phase separator (14) is transferred to pump (304) via line (302). During normal operation mode and/or transition mode, the concentrated polymer solution of line (302) being transferred from phase separator (14) to pump (304) can have a temperature of about 170° F. to about 300° F., such as about 200° F. to about 270° F., a pressure of about 50 psig to about 200 psig, such as about 65 psig to about 160 psig, a mass flow rate of about 200 Mlb/hr to about 800 Mlb/hr, such as about 220 Mlb/hr to about 1060 Mlb/hr, about 220 Mlb/hr to about 760 Mlb/hr, a vapor content of about 0 wt % to about 1 wt %, such as about 0 wt %, and/or a polymer content of about 20 wt % to about 70 wt %, such as about 25 wt % to about 60 wt %.

From pump (304), the concentrated polymer solution is transferred to stream splitter (70) via line (306). During normal operation mode and/or transition mode, the concentrated polymer solution of line (306) being transferred from pump (304) to stream splitter (70) can have a temperature of about 170° F. to about 300° F., such as about 200° F. to about 270° F., a pressure of about 500 psig to about 800 psig, such as about 550 psig to about 750 psig, a mass flow rate of about 200 Mlb/hr to about 800 Mlb/hr, such as about 220 Mlb/hr to about 1060 Mlb/hr, such as about 220 Mlb/hr to about 760 Mlb/hr, a vapor content of about 0 wt % to about 1 wt %, such as about 0 wt %, and/or a polymer content of about 20 wt % to about 70 wt %, such as about 25 wt % to about 60 wt %.

From stream splitter (70), the concentrated polymer solution of line (72) is transferred to separator (34) via line (72). During normal operation mode and/or transition mode, the concentrated solution phase of line (72) being transferred from stream splitter (70) to separator (34) can have a temperature of about 200° F. to about 300° F., such as about 220° F. to about 280° F., a pressure of about 500 psig to about 800 psig, such as about 550 psig to about 750 psig, a mass flow rate of about 200 Mlb/hr to about 350 Mlb/hr, such as about 220 Mlb/hr to about 270 Mlb/hr, a vapor content of about 0 wt % to about 1 wt %, such as about 0 wt %, and/or a polymer content of about 20 wt % to about 70 wt %, such as about 25 wt % to about 60 wt %.

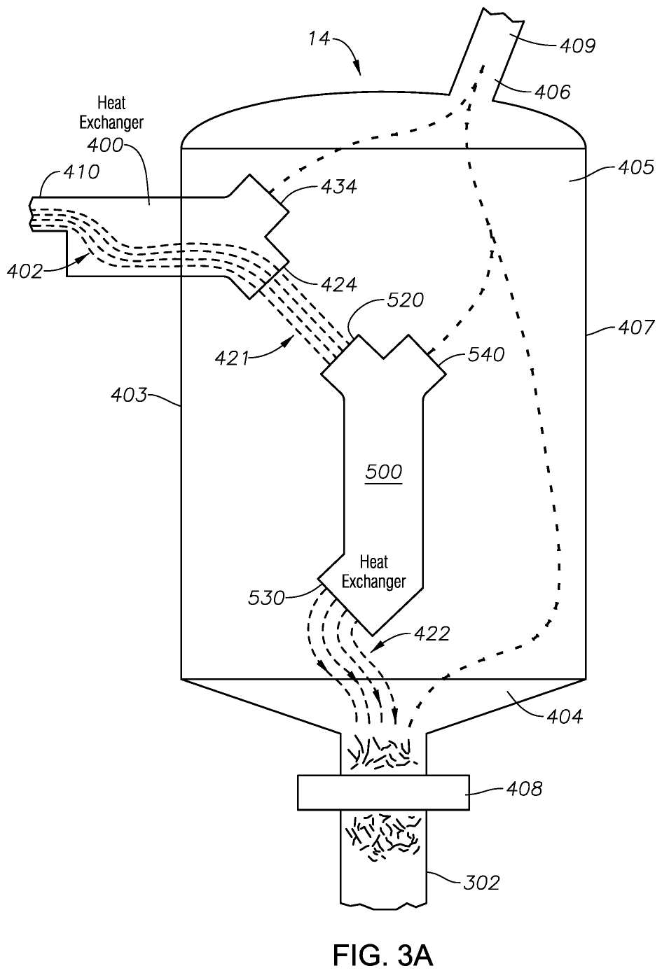

FIG. 3A is a phase separator (14) of plant (100), according to an embodiment. As shown in FIG. 3A, phase separator (14) is a static devolatilization separator. Phase separator (14) includes heat exchanger (400) and an inlet (410) for receiving the effluent (402) (e.g., reactor effluent or mixture of reactor effluent and concentrated polymer solution) from pressure let down valve (18) via line (11). As shown in FIG. 3A, heat exchanger (400) is partially disposed within phase separator (14), but alternatively can be disposed entirely within phase separator (14). Phase separator (14) includes a container (403) for receiving a first concentrated polymer solution (421). Container (403) has a lower sump region (404) for collecting a second concentrated polymer solution (422). Container (403) has an upper region (405) for discharging volatiles (406). Container (403) has a central region (407) between the lower sump region (404) and upper region (405). A discharge pump (408) in fluid communication with the lower sump region (404) discharges the second concentrated polymer solution (422) therefrom. An extraction line (409) provides discharging of volatiles (406) from container (403), and extraction line (409) is located in upper region (405) of phase separator (14), for example, extraction line (409) is located in a top ⅓ portion of phase separator (14).

Heat exchanger (400) has a volatiles discharge region (434) for discharging volatiles (406) toward extraction line (409).

A discharge opening (424) of heat exchanger (400) discharges the first concentrated polymer solution (421) downwardly towards the lower sump region (404) and a second heat exchanger (500) configured to receive the first concentrated polymer solution (421). Second heat exchanger (500) is configured to receive the first concentrated polymer solution (421) via an inlet (520) (which is an inner transition portion) and provide heat exchange with the first concentrated polymer solution (421) to form the second concentrated polymer solution (422) having a reduced volatiles content as compared to the first concentrated polymer solution (421). The second concentrated polymer solution (422) can exit heat exchanger (500) via outlet (530) (which is an outer transition portion) and move toward lower sump region (404). Separated volatiles provided by second heat exchanger (500) can exit second heat exchanger (500) at outlet (540) and move toward upper region (405) and ultimately extraction line (409).

Heat exchanger (400) and heat exchanger (500) can be operated, independently, at a temperature of about 170° F. to about 330° F., such as about 215° F. to about 300° F., a pressure of about 50 psig to about 200 psig, such as about 60 psig to about 170 psig, and/or a mass flow rate of about 200 Mlb/hr to about 800 Mlb/hr, such as about 250 Mlb/hr to about 760 Mlb/hr.

Heat exchanger (400) and heat exchanger (500) can be operated independently at 10 MMBtu/hr to about 30 MMBtu/hr, such as about 15 MMBtu/hr to about 25 MMBtu/hr, such as about 18 MMBtu/hr to about 22 MMBtu/hr. “MMBtu/hr” is Millions of British Thermal Units per hour. Because such heat exchangers are utilized in addition to heat exchanger (12), heat exchanger (12) can be operated at a lower heat input as compared to a conventional heat exchanger of a conventional recycle line, which often operate at about 60 MMBtu/hr. For example, heat exchanger (12) can be operated at about 25 MMBtu/hr to about 50 MMBtu/hr, such as about 35 MMBtu/hr to about 45 MMBtu/hr, such as about 35 MMBtu/hr to about 40 MMBtu/hr.

A phase separator having one or more heat exchanger(s) can provide improved devolatilization, particularly for highly viscous polymer products containing large quantities of volatiles and/or for which the final product specification allows for only very low concentrations of residual volatiles. Use of a first heat exchanger and second heat exchanger each disposed (partially or completely) within a phase separator can provide reduced volatiles content of the second concentrated polymer phase exiting the phase separator (as compared to if only one or zero heat exchangers is used disposed within the phase separator).

In addition, heat exchangers of the present disclosure can have a tube-tube design assembled in a bundle to provide, for example, up to 8000 m² of surface area. As compared to conventional tube bundles, a heat exchanger of the present disclosure provides substantial distribution of the reactor effluent (or mixture of reactor effluent and concentrated polymer solution) to increase the heat transfer surface area and vapor-liquid interface of the reactor effluent (or mixture of reactor effluent and concentrated polymer solution).

Conditions of phase separator (14) during devolatilization can include a temperature (e.g., average temperature of an interior volume of the phase separator) of about 150° C. to about 180° C., a pressure of about 75 psig to about 150 psig, and/or a mass flow rate (e.g., of first and/or second concentrated polymer solution(s)) of about 200 Mlb/hr to about 1000 Mlb/hr, such as about 250 Mlb/hr to about 775 Mlb/hr.

The second concentrated polymer solution (422) can be transferred from phase separator (14) to pump (304) via line (302), as described above.

FIG. 3B is a phase separator (14) of plant (100), according to an embodiment. As shown in FIG. 3B, phase separator (14) is a static devolatilization separator. Phase separator (14) includes effluent (402) and an inlet manifold (410) for receiving the effluent (402) (e.g., reactor effluent or mixture of reactor effluent and concentrated polymer solution) from pressure let down valve (18) via line (11). As shown in FIG. 3B, inlet manifold (410) is disposed within phase separator (14) and has a plurality of outlets (480) configured to provide effluent (402) into an internal cavity of phase separator (14). For example, phase separator (14) includes a container (403) for receiving a first concentrated polymer solution (421). Container (403) has a lower sump region (404) for collecting a second concentrated polymer solution (422). Container (403) has an upper region (405) for discharging volatiles (406). Container (403) has a central region (407) between the lower sump region (404) and upper region (405). A discharge pump (408) in fluid communication with the lower sump region (404) discharges the second concentrated polymer solution (422) therefrom. An extraction line (409) provides discharging of volatiles (406) from container (403), and extraction line (409) is located in upper region (405) of phase separator (14), for example, extraction line (409) is located in a top ⅓ portion of phase separator (14).

Inlet manifold (410) has a volatiles discharge region (434) for discharging volatiles (406) toward extraction line (409). Outlets (480) of inlet manifold (410) discharge the first concentrated polymer solution (421) downwardly towards the lower sump region (404) and a heat exchanger (500) configured to receive the first concentrated polymer solution (421). Heat exchanger (500) is configured to receive the first concentrated polymer solution (421) via one or more inlets (not shown) and provide heat exchange with the first concentrated polymer solution (421) to form the second concentrated polymer solution (422) having a reduced volatiles content as compared to the first concentrated polymer solution (421). The second concentrated polymer solution (422) can exit heat exchanger (500) via one or more outlets (not shown) and move toward lower sump region (404). Separated volatiles provided by second heat exchanger (500) can exit second heat exchanger (500) at one or more outlets (not shown) and move toward upper region (405) and ultimately extraction line (409).

Heat exchanger (500) can be operated at a temperature of about 170° F. to about 330° F., such as about 215° F. to about 300° F., a pressure of about 50 psig to about 200 psig, such as about 60 psig to about 170 psig, and/or a mass flow rate of about 200 Mlb/hr to about 800 Mlb/hr, such as about 250 Mlb/hr to about 760 Mlb/hr.

Heat exchanger (500) can be operated at 10 MMBtu/hr to about 30 MMBtu/hr, such as about 15 MMBtu/hr to about 25 MMBtu/hr, such as about 18 MMBtu/hr to about 22 MMBtu/hr. Because such a heat exchanger is utilized in addition to heat exchanger (12), heat exchanger (12) of FIG. 1 can be operated at a lower heat input as compared to a conventional heat exchanger of a conventional recycle line, which often operate at about 60 MMBtu/hr. For example, heat exchanger (12) can be operated at about 25 MMBtu/hr to about 50 MMBtu/hr, such as about 35 MMBtu/hr to about 45 MMBtu/hr, such as about 35 MMBtu/hr to about 40 MMBtu/hr.

A phase separator having one or more heat exchanger(s) can provide improved devolatilization, particularly for highly viscous polymer products containing large quantities of volatiles and/or for which the final product specification allows for only very low concentrations of residual volatiles. Use of a heat exchanger disposed within a phase separator can provide reduced volatiles content of the second concentrated polymer phase exiting the phase separator (as compared to zero heat exchangers are used disposed within the phase separator).

In addition, a heat exchanger of the present disclosure can have a tube-tube design assembled in a bundle to provide, for example, up to 8000 m² of surface area. As compared to conventional tube bundles, a heat exchanger of the present disclosure provides substantial distribution of the reactor effluent (or mixture of reactor effluent and concentrated polymer solution) to increase the heat transfer surface area and vapor-liquid interface of the reactor effluent (or mixture of reactor effluent and concentrated polymer solution).

Conditions of phase separator (14) during devolatilization can include a temperature (e.g., average temperature of an interior volume of the phase separator) of about 150° C. to about 180° C., a pressure of about 75 psig to about 150 psig, and/or a mass flow rate (e.g., of first and/or second concentrated polymer solution(s)) of about 200 Mlb/hr to about 1000 Mlb/hr, such as about 250 Mlb/hr to about 775 Mlb/hr.

The second concentrated polymer solution (422) can be transferred from phase separator (14) to pump (304) via line (302), as described above.

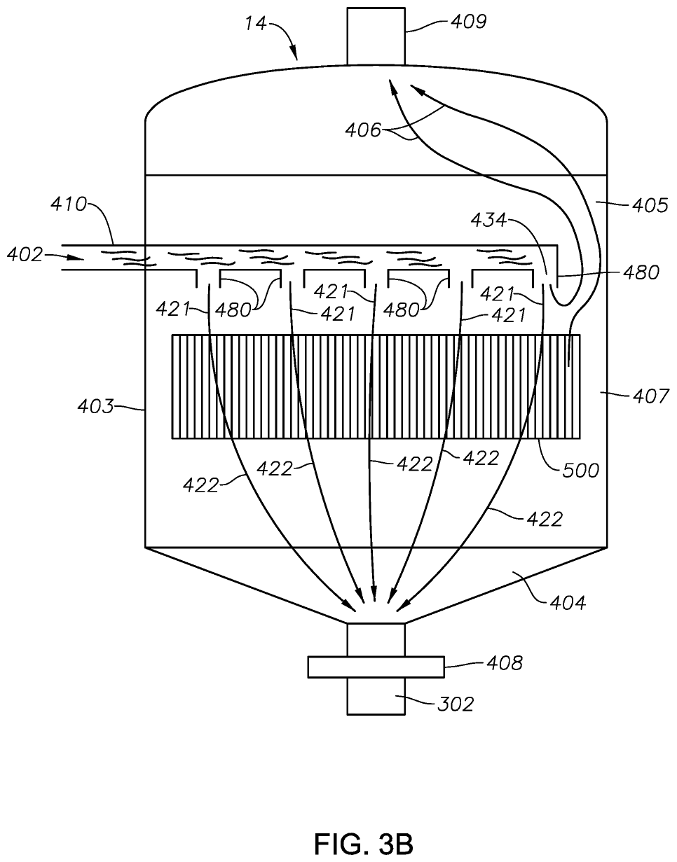

FIG. 4 is a heat exchanger (550), which can be used as a heat exchanger of FIG. 3A, according to an embodiment. Heat exchanger (550) can be heat exchanger (400) and/or heat exchanger (500) of FIG. 3. As shown in FIG. 4, heat exchanger (550) includes central body (510), two inner transition portions (520), two outer transition portions (530), and three tubular connetion portions (540). Of the two inner transition portions (520), one extends from the first end (520a) of the central body (510) and the other extends from the second end (520b) of the central body (510). Each of the two transition portions (530) extends from either outer end (520b) of respective inner transition portions (520). Each connection portion (540) has a tubular wall portion integrally formed with and extending from an outer envelope surface of respective one of the first and second end portions (530b), (530c) of respective outer transition portions (530). Tubular connection portions (540) can be circular and adapted to (A) receive the reactor effluent (or the mixture of the reactor effluent and concentrated polymer solution), (B) provide an outlet of volatiles into container (403) of a phase separator, or (C) provide an outlet of concentrated polymer solution (422). Heat exchanger (550) (e.g., component(s) of heat exchanger (550) such as central body (510)) can be formed of steel or a steel alloy.

Heat exchanger (550) can have a plurality of channels (not shown) disposed therein. The plurality of channels can form a checkered pattern, e.g., as described in U.S. Publication No. 2020/0300561, incorporated herein by reference in its entirety. The inner transition portion (520) has a length L in the main direction of at least 3 times a maximum width W of any channel disposed in the central body (510).

Alternatively, a heat exchanger can be a plate heat exchanger, such as the heat exchanger of FIG. 3B. A plate heat exchanger can have a plurality of first heat exchanger plates and a plurality of second heat exchanger plates, which are joined to each other and arranged side by side in such a way that a first plate interspace is formed between each pair of adjacent first heat exchanger plates and second heat exchanger plates and a second plate interspace between each pair of adjacent second heat exchanger plates and first heat exchanger plates. The first plate interspaces and the second plate interspaces are separated from each other and provided side by side in an alternating order in the plate package. Substantially each heat exchanger plate has at least a first porthole and a second porthole, where the first portholes form a first inlet channel to the first plate interspaces and the second portholes form a first outlet channel from the first plate interspaces.

For example, a plate heat exchanger can have a first outlet(s) that provides a volatiles outlet and a second outlet(s) that provides an outlet for concentrated polymer solution (421) or (422).

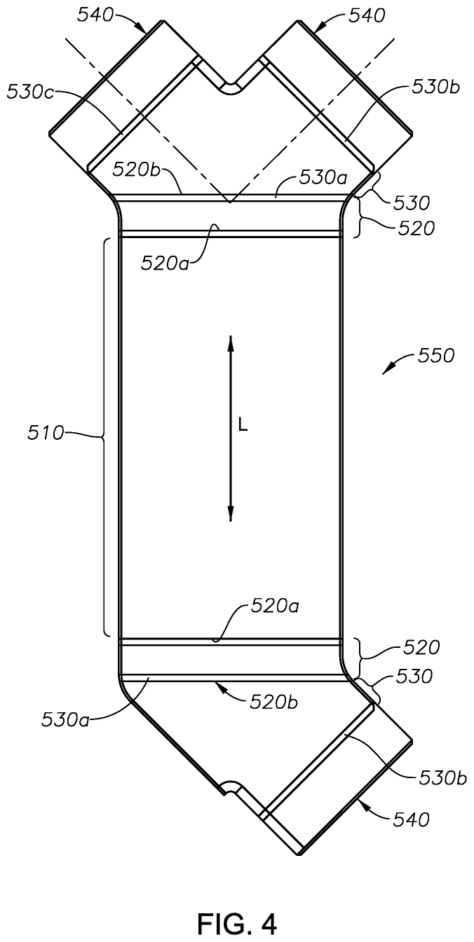

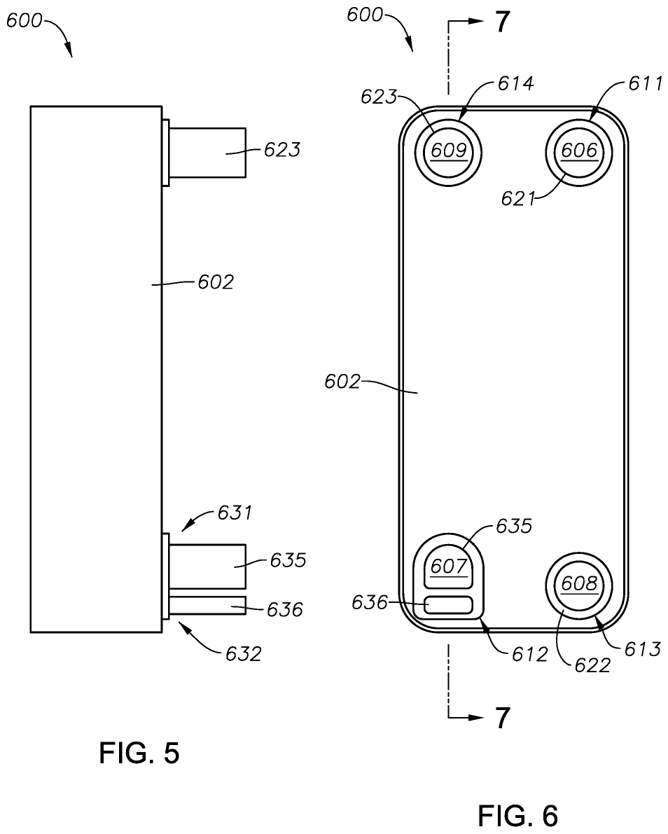

FIGS. 5 to 7 illustrate a plate heat exchanger (600). Plate heat exchanger (600) includes a plurality of heat exchanger plates (601), which form a plate package (602) and which each includes a main extension plane p, see FIG. 5. The heat exchanger plates (601) are pressed to such a shape that when the plates are provided beside each other to plate package (602), a plate interspace is formed between each pair of plates (601). The plate interspaces, which completely or partially also may be formed by distance members, for instance gaskets, provided between the plates, are arranged to form a plurality of first passages (603) for a reactor effluent (or mixture of reactor effluent and concentrated polymer solution) and a plurality of second passages (604) for a medium (e.g., heating fluid). The first passages (603) are separated from the second passages (604). Furthermore, the first passages (603) and the second passages (604) are arranged beside each other in an alternating order, e.g. substantially each first passage (603) is surrounded by two second passages (604).

The plate package (602) includes heat exchanger plates (601), which are connected to each other by any suitable method such as brazing, where heat exchanger plates (601) are substantially identical except for one of the end plates, which in the embodiment disclosed lacks portholes. Furthermore, plate package (602) includes four port channels (606), (607), (608) and (609). Each port channel (606), (607), (608) and (609) extends through plates (601) except for said one end plate. Two of the port channels (606) and (607) are in fluid communication with the first passages (603), where the port channel (606) forms a first inlet port channel and extends to a first inlet (611) for the reactor effluent (or mixture of reactor effluent and concentrated polymer solution), and the port channel (607) forms a first outlet port channel and extends to a first outlet (612) for the volatiles and concentrated polymer solution. The two other port channels (608) and (609) are in fluid communication with the second passages (604), where the port channel (608) forms a second inlet port channel (608) and extends to a second inlet (613) for the medium (heating fluid), and the port channel (609) forms a second inlet port channel and extends to a second outlet (614) for the medium. It is to be noted that the plate heat exchanger device may be of a type that has another number of port channels, for instance two or six port channels and/or another number of passages.

Each port channel (606), (608), and (609) is formed by an opening or a porthole in each heat exchanger plate (601) in the plate package (602) except for the one end plate. The portholes which form the port channels (606), (608), and (609), are circular viewed in the direction of the port channels (606), (608), and (609). Each port channel (606), (608), and (609) is connected to a respective conduit pipe (221), (222), (223) extending from the plate package (602) for the supply and removal, respectively, of medium (such as the reactor effluent, the mixture of reactor effluent and concentrated polymer solution, volatiles, first/second concentrated polymer solution, or heating fluid). For example, the pipe (221) and the port channel (606) permit feeding and transport of the reactor effluent or the mixture of reactor effluent and concentrated polymer solution to the first passages (603). The pipe (622) and the port channel (608) permit feeding and transport of a medium (such as a heating fluid) to the second passages (604), and the pipe (623) and the port channel (609) permit discharge and transport of the medium (heating fluid) from the second passages (604).

The plate package (602) has during use an upper end and a lower end located below the upper end with regard to the direction of gravity, where the first inlet (611) is located in the proximity of the upper end and the first outlet (612) is located in the proximity of the lower end. The second inlet (613) operates according to the counterflow principle, located at the lower end whereas the second outlet (614) is located at the upper end. It is to be noted that the plate heat exchanger also may be designed to operate according to the parallel flow principle.

The plate heat exchanger is arranged to provide heating of the reactor effluent (or mixture of reactor effluent and concentrated polymer solution) in the first passages (603) by use of the medium (heating fluid) in the second passages (604). For example, due to the heating of the reactor effluent (or mixture of reactor effluent and concentrated polymer solution), volatiles will be removed from the reactor effluent (or mixture of reactor effluent and concentrated polymer solution). One or more of the heat exchanger plates can include a heat transfer area with a corrugation including ridges and valleys.

The port channel (607), forming the first outlet (612), includes or forms a volatiles outlet (631), which is arranged to permit discharge of volatiles of the reactor effluent (or mixture of reactor effluent and concentrated polymer solution), and a liquid outlet (632), which is arranged to permit discharge of concentrated polymer solution. The liquid outlet (632) is provided in or in the proximity of the gas outlet (631). In the first embodiment, the first outlet (612) is formed by a porthole. The port channel (607) is however divided by means of a dividing piece (633), which extends in the port channel (607) from said one end plate in such a way that the upper volatiles outlet (631) and the lower volatiles outlet (632) are formed. The volatiles outlet (631) will thus be separated from the concentrated polymer outlet (632).

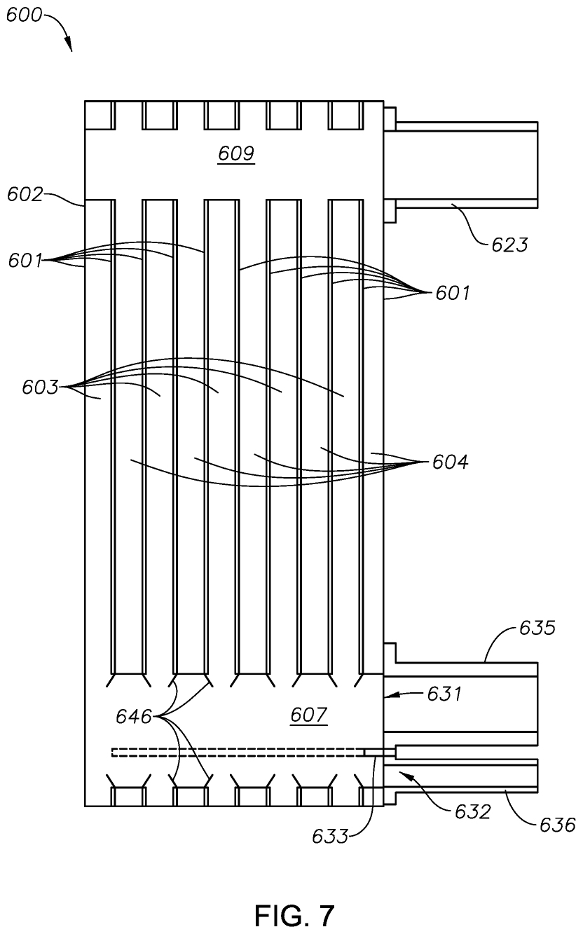

The outlet opening of the volatiles outlet (631) has a center point which during normal use is located at a higher level than a center point of the outlet opening of the liquid outlet (632) with regard to the gravity. FIG. 7 illustrates with continuous lines a dividing piece (633) extending a short distance into the port channel (607). However, with dashed lines it is shown that the dividing piece may extend through substantially the whole length of the port channel (607). The dividing piece (633) may include or be formed by a simple sheet which may have a somewhat curved shape being convex seen from the gas outlet (631), where concentrated polymer on the dividing piece (633) may flow outwardly and downwardly from the volatiles outlet (631) or, preferably, from the concentrated polymer outlet (632). In alternative embodiments, a plate heat exchanger does not have a dividing piece (633).

The volatiles outlet (631) includes or is connectable to a volatiles discharge conduit (635) extending from the plate package (602) for discharge and transport of volatiles. The concentrated polymer outlet (632) includes or is connectable to a discharge conduit (636), which also extends from the plate package (602) and is separated from the volatiles discharge conduit for separate discharge and transport of concentrated polymer.

The heat exchanger plates, delimiting substantially each passage (603), are configured in such a way that the transition between the first passage (603) and the port channel (607) of the first outlet (612) forms a throttling for the heated components of the reactor effluent (or mixture of reactor effluent and concentrated polymer solution) flowing out into the port channel (607). The throttling is formed by an edge area (646), which extends around at least the first outlet (612) and inwardly towards a centre plane of the plate interspace forming the first passage (603).

### Additional Aspects

The present disclosure provides, among others, the following aspects, each of which may be considered as optionally including any alternate aspects.

Clause 1. A process of forming a polymer comprising:
supplying a feed having one or more olefin monomers and a solvent;
introducing the feed with a catalyst to form a reaction mixture in a reactor;
removing a reactor effluent from the reactor;
comingling, in a mixer or in a line, the reactor effluent with a first concentrated polymer solution to form a mixture;
introducing the mixture to a heat exchanger to form a heated mixture;
introducing the heated mixture to a pressure let down valve followed by introducing the heated mixture to a phase separator;
removing a second concentrated polymer solution from the phase separator; and
introducing the second concentrated polymer solution to the mixer or the line.

Clause 2. The process of Clause 1, wherein the reactor is a continuous stirred-tank reactor.

Clause 3. The process of Clauses 1 or 2, wherein introducing the second concentrated polymer solution to the mixer or the line is performed at a rate about 500,000 or less lb/hr.

Clause 4. The process of any of Clauses 1 to 3, further comprising introducing the second concentrated polymer solution to a stream splitter configured to split the second concentrated polymer solution into:
a first portion that is the second concentrated polymer solution introduced to the mixer or the line; and
a second portion, the process further comprising introducing the second portion to a second phase separator.

Clause 5. The process of any of Clauses 1 to 4, wherein the monomers comprise octene, butene, propylene and ethylene.

Clause 6. The process of any of Clauses 1 to 5, wherein, at a time during the introducing the second concentrated polymer solution to the mixer or the line, the second concentrated polymer solution has:
a temperature of about 215° F. to about 280° F.,
a pressure of about 580 psig to about 650 psig,
a mass flow rate of about 450 Mlb/hr to about 540 Mlb/hr,
a vapor content of about 0 wt % to about 1 wt %, and
a polymer content of about 25 wt % to about 50 wt %.

Clause 7. The process of any of Clauses 1 to 6, wherein, at a time during the introducing the heated mixture to the pressure let down valve, the heated mixture has:
a temperature of about 240° F. to about 340° F.,
a pressure of about 435 psig to about 550 psig,
a mass flow rate of about 500 Mlb/hr to about 1060 Mlb/hr,
a vapor content of about 0 wt % to about 1 wt %, and
a polymer content of about 15 wt % to about 40 wt %.

Clause 8. The process of any of Clauses 1 to 7, further comprising:
ceasing the introducing the second concentrated polymer solution to the mixer or the line;
ceasing the comingling the reactor effluent with the first concentrated polymer solution;
introducing the reactor effluent to the heat exchanger to form a heated reactor effluent;
introducing the heated reactor effluent to the pressure let down valve followed by introducing the heated reactor effluent to the phase separator; and
removing a third concentrated polymer solution from the phase separator.

Clause 9. The process of any of Clauses 1 to 8, wherein, at a time during the introducing the heated reactor effluent to the pressure let down valve, the heated reactor effluent has:
a temperature of about 240° F. to about 330° F.,
a pressure of about 435 psig to about 550 psig,
a mass flow rate of about 450 Mlb/hr to about 560 Mlb/hr,
a vapor content of about 0 wt % to about 1 wt %, and
a polymer content of about 10 wt % to about 30 wt %.

Clause 10. The process of any of Clauses 1 to 9, wherein:
at a time during the introducing the mixture to the heat exchanger to form the heated mixture, the heated mixture has:
   a temperature of about 180° F. to about 280° F.,
   a pressure of about 580 psig to about 650 psig,
   a mass flow rate of about 1025 Mlb/hr to about 1075 Mlb/hr,
   a vapor content of about 0 wt % to about 1 wt %, and
   a polymer content of about 10 wt % to about 30 wt %; and
at a time during the introducing the reactor effluent to the heat exchanger to form the heated reactor effluent, the heated reactor effluent has:
   a temperature of about 140° F. to about 320° F.,
   a pressure of about 580 psig to about 650 psig,
   a mass flow rate of about 500 Mlb/hr to about 600 Mlb/hr,
   a vapor content of about 0 wt % to about 1 wt %, and
   a polymer content of about 5 wt % to about 35 wt %.

Clause 11. The process of any of Clauses 1 to 10, wherein:
at a time during the introducing the heated mixture to the phase separator, the heated mixture has:
   a temperature of about 200° F. to about 270° F.,
   a pressure of about 70 psig to about 170 psig,
   a mass flow rate of about 400 Mlb/hr to about 1,100 Mlb/hr,
   a vapor content of about 15 wt % to about 50 wt %, and
   a polymer content of about 15 wt % to about 40 wt %; and
at a time during the introducing the heated reactor effluent to the phase separator, the heated reactor effluent has:
   a temperature of about 190° F. to about 280° F.,
   a pressure of about 60 psig to about 170 psig,
   a mass flow rate of about 500 Mlb/hr to about 600 Mlb/hr,
   a vapor content of about 20 wt % to about 40 wt %, and
   a polymer content of about 10 wt % to about 30 wt %.

Clause 12. The process of any of Clauses 1 to 11, wherein, at a time during the introducing the second portion to the second phase separator, the second portion has:
a temperature of about 220° F. to about 280° F.,
a pressure of about 550 psig to about 750 psig,
a mass flow rate of about 220 Mlb/hr to about 270 Mlb/hr,
a vapor content of about 0 wt % to about 1 wt %, and
a polymer content of about 25 wt % to about 60 wt %.

Clause 13. The process of any of Clauses 1 to 12, wherein introducing the heated mixture to the phase separator is performed by introducing the heated mixture to an inlet of the phase separator, wherein a second heat exchanger is coupled with the inlet of the phase separator.

Clause 14. The process of any of Clauses 1 to 13, wherein introducing the heated mixture to the phase separator further comprises introducing the heated mixture to a third heat exchanger disposed in the phase separator below the second heat exchanger.

Clause 15. The process of any of Clauses 1 to 14, wherein the second heat exchanger comprises a first plurality of tubes and the third heat exchanger comprises a second plurality of tubes.

Clause 16. The process of any of Clauses 1 to 15, wherein the second heat exchanger is operated at:
a temperature of about 215° F. to about 300° F.,
a pressure of about 60 psig to about 170 psig, and
a mass flow rate of about 250 Mlb/hr to about 1060 Mlb/hr.

Clause 17. The process of any of Clauses 1 to 16, wherein third heat exchanger is operated at:
a temperature of about 215° F. to about 300° F.,
a pressure of about 60 psig to about 170 psig, and
a mass flow rate of about 250 Mlb/hr to about 760 Mlb/hr.

Clause 18. The process of any of Clauses 1 to 17, wherein the first heat exchanger is operated at about 25 MMBtu/hr to about 50 MMBtu/hr.

Clause 19. The process of any of Clauses 1 to 18, wherein:
the second heat exchanger is operated at about 10 MMBtu/hr to about 30 MMBtu/hr, and
the third heat exchanger is operated at about 10 MMBtu/hr to about 30 MMBtu/hr.

Clause 20. The process of any of Clauses 1 to 19, wherein:
the first heat exchanger is operated at about 35 MMBtu/hr to about 40 MMBtu/hr,
the second heat exchanger is operated at about 18 MMBtu/hr to about 22 MMBtu/hr, and
the third heat exchanger is operated at about 18 MMBtu/hr to about 22 MMBtu/hr.

Clause 21. The process of any of Clauses 1 to 21, further comprising operating the phase separator at:
a temperature of about 220° F. to about 300° F.,
a pressure of about 60 psig to about 170 psig, and
a mass flow rate of about 250 Mlb/hr to about 775 Mlb/hr.

Clause 22. A plant for forming a polymer, the plant comprising:
a polymerization reactor coupled with a phase separator;
a heat exchanger and a pressure let down valve disposed between the polymerization reactor and the phase separator, the heat exchanger coupled with the polymerization reactor and the pressure let down valve, the pressure let down valve coupled with the phase separator; and
a stream splitter coupled with the phase separator and coupled with a line at a location upstream of the heat exchanger and the pressure let down valve.

Clause 23. The plant of Clause 22, further comprising a second phase separator coupled with the stream splitter.

Clause 24. The plant of Clauses 22 or 23, further comprising a vacuum devolatilizing extruder coupled with the second phase separator.

Clause 25. The plant of any of Clauses 22 to 24, further comprising one or more valves coupled with a second line, wherein the one or more valves is configured to block flow of material in the second line from entering the first line at the location upstream of the heat exchanger and the pressure let down valve.

Clause 26. The plant of any of Clauses 22 to 25, wherein the phase separator comprises a second heat exchanger coupled with an inlet of the phase separator.

Clause 27. The plant of any of Clauses 22 to 26, wherein the phase separator further comprises a third heat exchanger disposed in the phase separator below the second heat exchanger.

Overall, plants and processes of the present disclosure provide reduced transition time between polymer grades in a way that also reduces the amount of off-spec material (e.g., degraded polymer and less recycled concentrated polymer in the recycle line), as compared to conventional plants and processes.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A process of forming a polymer comprising:
supplying a feed having one or more olefin monomers and a solvent;
introducing the feed with a catalyst to form a reaction mixture in a reactor;
removing a reactor effluent from the reactor;
comingling, in a mixer or in a line, the reactor effluent with a first concentrated polymer solution to form a mixture;
introducing the mixture to a heat exchanger to form a heated mixture;
introducing the heated mixture to a pressure let down valve followed by introducing the heated mixture to a phase separator;
removing a second concentrated polymer solution from the phase separator; and
introducing the second concentrated polymer solution to the mixer or the line.

2. The process of claim 1, wherein the reactor is a continuous stirred-tank reactor.

3. The process of claim 1, wherein introducing the second concentrated polymer solution to the mixer or the line is performed at a rate about 500,000 or less lb/hr.

4. The process of any of claim 1, further comprising introducing the second concentrated polymer solution to a stream splitter configured to split the second concentrated polymer solution into:
a first portion that is the second concentrated polymer solution introduced to the mixer or the line; and
a second portion, the process further comprising introducing the second portion to a second phase separator.

5. The process of claim 1, wherein the monomers comprise octene, butene, propylene and ethylene.

6. The process of claim 1, wherein, at a time during the introducing the second concentrated polymer solution to the mixer or the line, the second concentrated polymer solution has:
a temperature of about 215° F. to about 280° F.,
a pressure of about 580 psig to about 650 psig,
a mass flow rate of about 450 Mlb/hr to about 540 Mlb/hr,
a vapor content of about 0 wt % to about 1 wt %, and
a polymer content of about 25 wt % to about 50 wt %.

7. The process of claim 1, wherein, at a time during the introducing the heated mixture to the pressure let down valve, the heated mixture has:
a temperature of about 240° F. to about 340° F.,
a pressure of about 435 psig to about 550 psig,
a mass flow rate of about 500 Mlb/hr to about 1060 Mlb/hr,
a vapor content of about 0 wt % to about 1 wt %, and
a polymer content of about 15 wt % to about 40 wt %.

8. The process claim 1, further comprising:
ceasing the introducing the second concentrated polymer solution to the mixer or the line;
ceasing the comingling the reactor effluent with the first concentrated polymer solution;
introducing the reactor effluent to the heat exchanger to form a heated reactor effluent;
introducing the heated reactor effluent to the pressure let down valve followed by introducing the heated reactor effluent to the phase separator; and
removing a third concentrated polymer solution from the phase separator.

9. The process of claim 1, wherein, at a time during the introducing the heated reactor effluent to the pressure let down valve, the heated reactor effluent has:
a temperature of about 240° F. to about 330° F.,
a pressure of about 435 psig to about 550 psig,
a mass flow rate of about 450 Mlb/hr to about 560 Mlb/hr,
a vapor content of about 0 wt % to about 1 wt %, and
a polymer content of about 10 wt % to about 30 wt %.

10. The process of claim 1, wherein: at a time during the introducing the mixture to the heat exchanger to form the heated mixture, the heated mixture has:
a temperature of about 180° F. to about 280° F.,
a pressure of about 580 psig to about 650 psig,
a mass flow rate of about 1025 Mlb/hr to about 1075 Mlb/hr,
a vapor content of about 0 wt % to about 1 wt %, and
a polymer content of about 10 wt % to about 30 wt %; and
at a time during the introducing the reactor effluent to the heat exchanger to form the heated reactor effluent, the heated reactor effluent has:
a temperature of about 140° F. to about 320° F.,
a pressure of about 580 psig to about 650 psig,
a mass flow rate of about 500 Mlb/hr to about 600 Mlb/hr,
a vapor content of about 0 wt % to about 1 wt %, and
a polymer content of about 5 wt % to about 35 wt %.

11. The process claim 1, wherein:
at a time during the introducing the heated mixture to the phase separator, the heated mixture has:
a temperature of about 200° F. to about 270° F.,
a pressure of about 70 psig to about 170 psig,
a mass flow rate of about 400 Mlb/hr to about 1,100 Mlb/hr,
a vapor content of about 15 wt % to about 50 wt %, and
a polymer content of about 15 wt % to about 40 wt %; and
at a time during the introducing the heated reactor effluent to the phase separator, the heated reactor effluent has:
a temperature of about 190° F. to about 280° F.,
a pressure of about 60 psig to about 170 psig,
a mass flow rate of about 500 Mlb/hr to about 600 Mlb/hr,
a vapor content of about 20 wt % to about 40 wt %, and
a polymer content of about 10 wt % to about 30 wt %.

12. The process claim 1, wherein, at a time during the introducing the second portion to the second phase separator, the second portion has:
a temperature of about 220° F. to about 280° F.,
a pressure of about 550 psig to about 750 psig,
a mass flow rate of about 220 Mlb/hr to about 270 Mlb/hr,
a vapor content of about 0 wt % to about 1 wt %, and
a polymer content of about 25 wt % to about 60 wt %.

13. The process of claim 1, wherein introducing the heated mixture to the phase separator is performed by introducing the heated mixture to an inlet of the phase separator, wherein a second heat exchanger is coupled with the inlet of the phase separator.

14. The process of claim 1, wherein introducing the heated mixture to the phase separator further comprises introducing the heated mixture to a third heat exchanger disposed in the phase separator below the second heat exchanger.

15. The process of claim 1, wherein the second heat exchanger comprises a first plurality of tubes and the third heat exchanger comprises a second plurality of tubes.

16. The process of claim 1, wherein the second heat exchanger is operated at:
a temperature of about 215° F. to about 300° F.,
a pressure of about 60 psig to about 170 psig, and
a mass flow rate of about 250 Mlb/hr to about 1060 Mlb/hr.

17. The process of claim 1, wherein third heat exchanger is operated at:
a temperature of about 215° F. to about 300° F.,
a pressure of about 60 psig to about 170 psig, and
a mass flow rate of about 250 Mlb/hr to about 760 Mlb/hr.

18. The process of claim 1, wherein the first heat exchanger is operated at about 25 MMBtu/hr to about 50 MMBtu/hr.

19. The process of claim 1, wherein:
the second heat exchanger is operated at about 10 MMBtu/hr to about 30 MMBtu/hr, and
the third heat exchanger is operated at about 10 MMBtu/hr to about 30 MMBtu/hr.

20. The process of claim 1, wherein:
the first heat exchanger is operated at about 35 MMBtu/hr to about 40 MMBtu/hr,
the second heat exchanger is operated at about 18 MMBtu/hr to about 22 MMBtu/hr, and
the third heat exchanger is operated at about 18 MMBtu/hr to about 22 MMBtu/hr.

21. The process of claim 1, further comprising operating the phase separator at:
a temperature of about 220° F. to about 300° F.,
a pressure of about 60 psig to about 170 psig, and
a mass flow rate of about 250 Mlb/hr to about 775 Mlb/hr.

22. A plant for forming a polymer, the plant comprising:
a polymerization reactor coupled with a phase separator;
a heat exchanger and a pressure let down valve disposed between the polymerization reactor and the phase separator, the heat exchanger coupled with the polymerization reactor and the pressure let down valve, the pressure let down valve coupled with the phase separator; and
a stream splitter coupled with the phase separator and coupled with a line at a location upstream of the heat exchanger and the pressure let down valve.

23. The plant of claim 22, further comprising a second phase separator coupled with the stream splitter.

24. The plant of claim 22, further comprising a vacuum devolatilizing extruder coupled with the second phase separator.

25. The plant of claim 22, further comprising one or more valves coupled with a second line, wherein the one or more valves is configured to block flow of material in the second line from entering the first line at the location upstream of the heat exchanger and the pressure let down valve.

26. The plant of claim 22, wherein the phase separator comprises a second heat exchanger coupled with an inlet of the phase separator.

27. The plant of claim 22, wherein the phase separator further comprises a third heat exchanger disposed in the phase separator below the second heat exchanger.
